(19) United States
(12) Patent Application Publication
(10) Pub. No.: US 2024/0255861 A1
(43) Pub. Date: Aug. 1, 2024

(54) ELECTROPHOTOGRAPHIC APPARATUS INCLUDING ELECTROPHOTOGRAPHIC PHOTOSENSITIVE MEMBER AND INTERMEDIATE TRANSFER BELT, AND METHOD OF PRODUCING THE ELECTROPHOTOGRAPHIC APPARATUS

(71) Applicant: CANON KABUSHIKI KAISHA, Tokyo (JP)

(72) Inventors: CHISATO MURATA, Chiba (JP); EILEEN TAKEUCHI, Tokyo (JP); HARUKI MORI, Chiba (JP); NAOTO KAMEYAMA, Tokyo (JP); KEIJI KARUBE, Ibaraki (JP)

(21) Appl. No.: 18/410,380

(22) Filed: Jan. 11, 2024

(30) Foreign Application Priority Data
Jan. 18, 2023 (JP) 2023-005963
Dec. 12, 2023 (JP) 2023-209556

(51) Int. Cl. G03G 7/00; G03G 15/01

(52) U.S. Cl. CPC G03G 7/008; G03G 7/0053; G03G 15/0131

(57) ABSTRACT

Provided is an electrophotographic apparatus including: an electrophotographic photosensitive member; and an intermediate transfer belt that is allowed to be brought into abutment against the electrophotographic photosensitive member, wherein the electrophotographic photosensitive member contains polytetrafluoroethylene particles, a binding material, and a polymer A including a specific structural unit, and wherein the intermediate transfer belt contains a perfluoropolyether, a binding material, and a polymer B including a specific structural unit.

### BACKGROUND OF THE DISCLOSURE

### Field of the Disclosure

The present disclosure relates to an electrophotographic apparatus including an electrophotographic photosensitive member and an intermediate transfer belt for an electrophotographic apparatus, and to a method of producing the electrophotographic apparatus.

### Description of the Related Art

As an electrophotographic photosensitive member to be mounted onto an electrophotographic apparatus, there is widely used an electrophotographic photosensitive member containing an organic photoconductive substance (charge-generating substance). In recent years, an improvement in mechanical durability (abrasion resistance) of the electrophotographic photosensitive member has been required for the purposes of lengthening the lifetime of the electrophotographic photosensitive member and improving image quality at the time of its repeated use.

An example of a technology of improving the abrasion resistance of the electrophotographic photosensitive member is a method including incorporating fluorine atom-containing resin particles into the surface layer of the electrophotographic photosensitive member to reduce friction between the surface layer and a contact member such as a cleaning blade. In Japanese Patent Application Laid-Open No. H06-332219, there is a disclosure of a technology including forming a surface layer through use of a dispersion liquid of fluorine atom-containing resin particles such as polytetrafluoroethylene resin particles as a coating liquid for a surface layer.

In addition, at the time of the preparation of the dispersion liquid of the fluorine atom-containing resin particles, there has been known a method including using a (meth)acrylic polymer containing a fluorine atom as a dispersant for the fluorine atom-containing resin particles for the purpose of improving their dispersibility. In Japanese Patent Application Laid-Open No. 2009-104145, there is a disclosure of a technology of improving the dispersibility of the fluorine atom-containing resin particles through use of a fluorine atom-containing (meth)acrylic polymer having a specific structure as a dispersant.

In an electrophotographic image forming apparatus, there is widely adopted a tandem system including superimposing toner images of colors of Y, M, C, and K on an intermediate transfer belt and then collectively transferring the toner images onto paper, to thereby provide a full-color image.

A semiconductive belt is generally used as the intermediate transfer belt used here, and there is known a belt formed by dispersing carbon black in a resin, such as polyimide or polyamide, as a typical belt.

Under such circumstances, there is a demand for a further improvement in transfer characteristic of the intermediate transfer belt in an electrophotographic apparatus required to have high speed and high durability. As one of attempts, an attempt has been made to improve the transfer characteristics by subjecting the surface of the intermediate transfer belt to various processes. In Japanese Patent Application Laid-Open No. 2021-47236, there has been proposed an intermediate transfer member having transfer efficiency enhanced by coating the surface of the intermediate transfer member with a fluorine compound having water repellency and oil repellency onto in order to reduce the adhesive force of a developer to the surface of the intermediate transfer member. In addition, in Japanese Patent Application Laid-Open No. 2019-12265, there is a disclosure of a method including using, at the time of the dispersion of a perfluoropolyether having water repellency in a surface layer, a (meth)acrylic polymer containing a fluorine atom as a dispersant for a perfluoropolyether for the purpose of enhancing dispersibility.

An electrophotographic apparatus including: an electrophotographic photosensitive member, which is produced by a technology as disclosed in Japanese Patent Application Laid-Open No. 2009-104145 and includes a surface layer excellent in dispersibility of fluorine atom-containing resin particles; and an intermediate transfer belt, which is produced by a technology as disclosed in Japanese Patent Application Laid-Open No. 2019-12265, and includes a surface layer excellent in dispersibility of a perfluoropolyether and is allowed to be brought into abutment against the electrophotographic photosensitive member, is excellent in abrasion resistance of the electrophotographic photosensitive member and is also excellent in stable formation of a high-quality electrophotographic image. However, when the operation of the electrophotographic apparatus is suspended for a long period of time under a state in which the electrophotographic photosensitive member and the intermediate transfer belt are brought into abutment against each other, the perfluoropolyether dispersed in the surface layer of the intermediate transfer belt may exude and permeate the electrophotographic photosensitive member to cause an image defect. Thus, in the electrophotographic apparatus including: the electrophotographic photosensitive member produced by using a (meth)acrylic polymer containing a fluorine atom as a dispersant for fluorine atom-containing resin particles; and the intermediate transfer belt produced by using a (meth)acrylic polymer containing a fluorine atom as a dispersant for a perfluoropolyether, which is brought into abutment against the photosensitive member, there is room for improvement with respect to the suppression of an image defect caused by exudation of a perfluoropolyether from the intermediate transfer belt to the electrophotographic photosensitive member after long-term suspension.

One aspect of the present disclosure is directed to provide an electrophotographic apparatus in which an image defect caused by exudation of a perfluoropolyether from an intermediate transfer belt to an electrophotographic photosensitive member is suppressed.

In addition, another aspect of the present disclosure is directed to provide a method of producing the electrophotographic apparatus.

### SUMMARY OF THE DISCLOSURE

According to one aspect of the present disclosure, there is provided an electrophotographic apparatus including: an electrophotographic photosensitive member; and an intermediate transfer belt that is allowed to be brought into abutment against the electrophotographic photosensitive member, wherein the electrophotographic photosensitive member includes a surface layer containing polytetrafluoroethylene particles, a binding material, and a polymer A including a structural unit having a perfluoroalkyl group, wherein the intermediate transfer belt includes a surface layer containing a perfluoropolyether, a binding material, and a polymer B including a structural unit having a perfluoroalkyl group, wherein the polymer A includes a structural unit represented by the following formula (1) as the structural unit having a perfluoroalkyl group, and wherein the polymer B includes a structural unit represented by the following formula (2) as the structural unit having a perfluoroalkyl group:

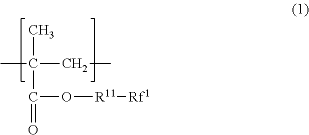

in the formula (1), R¹¹ represents a single bond or an alkylene group having 1 or more to 3 or less carbon atoms, and Rf¹ represents a perfluoroalkyl group having 1 or more to 5 or less carbon atoms;

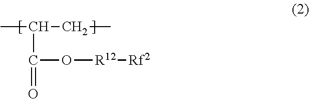

in the formula (2), R¹² represents a single bond or an alkylene group having 1 or more to 3 or less carbon atoms, and Rf² represents a perfluoroalkyl group having 1 or more to 5 or less carbon atoms.

In addition, according to another aspect of the present disclosure, there is provided a method of producing the electrophotographic apparatus.

Further features of the present disclosure will become apparent from the following description of exemplary embodiments with reference to the attached drawings.

### BRIEF DESCRIPTION OF THE DRAWINGS

FIG. 1 is a schematic view for illustrating an example of the configuration of an electrophotographic photosensitive member of the present disclosure.

FIG. 2 is a view for illustrating an example of a polishing machine using a polishing sheet.

FIG. 3 is a view for illustrating an example of the schematic configuration of each of a process cartridge having mounted thereon the electrophotographic photosensitive member of the present disclosure and an electrophotographic apparatus including the process cartridge.

FIG. 4 is a schematic view for illustrating an example of a process cartridge including the electrophotographic photosensitive member of the present disclosure.

FIG. 5 is a schematic view for illustrating an example of an electrophotographic apparatus including the electrophotographic photosensitive member of the present disclosure.

FIG. 6 is a schematic view of a cross-section of an electrophotographic intermediate transfer belt of the present disclosure.

### DESCRIPTION OF THE EMBODIMENTS

The present disclosure is described below in detail by way of exemplary embodiments.

The inventors have made investigations, and as a result, have found that in an electrophotographic apparatus including: an electrophotographic photosensitive member; and an intermediate transfer belt that is allowed to be brought into abutment against the electrophotographic photosensitive member, wherein the electrophotographic photosensitive member includes a surface layer containing polytetrafluoroethylene particles, a binding material, and a polymer A including a structural unit having a perfluoroalkyl group, wherein the intermediate transfer belt includes a surface layer containing a perfluoropolyether, a binding material, and a polymer B including a structural unit having a perfluoroalkyl group, wherein the polymer A includes a structural unit represented by the following formula (1) as the structural unit having a perfluoroalkyl group, and wherein the polymer B includes a structural unit represented by the following formula (2) as the structural unit having a perfluoroalkyl group:

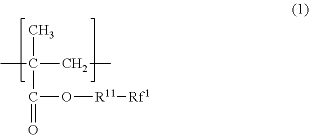

in the formula (1), R¹¹ represents a single bond or an alkylene group having 1 or more to 3 or less carbon atoms, and Rf¹ represents a perfluoroalkyl group having 1 or more to 5 or less carbon atoms;

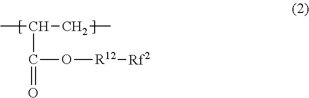

in the formula (2), R¹² represents a single bond or an alkylene group having 1 or more to 3 or less carbon atoms, and Rf² represents a perfluoroalkyl group having 1 or more to 5 or less carbon atoms, the occurrence of an image defect caused by exudation of a perfluoropolyether from an intermediate transfer belt to the surface of an electrophotographic photosensitive member in long-term suspension is suppressed.

Here, the inventors have conceived that the polymer A including the structural unit represented by the formula (1) functions as a dispersant for polytetrafluoroethylene particles in a step of preparing a coating liquid for a surface layer for forming the surface layer of the electrophotographic photosensitive member. In addition, the inventors have conceived that the polymer B including the structural unit represented by the formula (2) functions as a dispersant for a perfluoropolyether in a step of preparing a coating liquid for a surface layer for forming the surface layer of the intermediate transfer belt.

The inventors have assumed as described below as to the reason why the electrophotographic apparatus including the electrophotographic photosensitive member of the present disclosure and the intermediate transfer belt of the present disclosure is excellent in suppressing effect on the occurrence of an image defect that occurs at the time of printing after long-term suspension under a state in which the electrophotographic photosensitive member and the intermediate transfer belt are brought into abutment against each other.

When particles or a liquid containing a fluorine atom is dispersed in a resin, a dispersant containing a fluorine atom may be used for uniform dispersion. The same also applies to the case in which polytetrafluoroethylene particles are dispersed in the surface layer of the electrophotographic photosensitive member and the case in which a perfluoropolyether is dispersed in the surface layer of the intermediate transfer belt. The dispersant containing a fluorine atom may be used in any of those cases. When the same dispersant is used in the electrophotographic photosensitive member and the intermediate transfer belt that is brought into abutment against the electrophotographic photosensitive member, or when such dispersants as described below are used: a dispersant in the electrophotographic photosensitive member has affinity for a perfluoropolyether higher than that of a dispersant in the intermediate transfer belt that is brought into abutment against the electrophotographic photosensitive member, an image defect may occur at the time of printing after long-term suspension under a state in which the electrophotographic photosensitive member and the intermediate transfer belt are brought into abutment against each other. It is conceived that the foregoing is caused by the following: the perfluoropolyether dispersed in the surface layer of the intermediate transfer belt exudes from an intermediate transfer belt portion that is brought into abutment against the electrophotographic photosensitive member toward the surface of the electrophotographic photosensitive member having higher affinity for a perfluoropolyether to permeate the electrophotographic photosensitive member.

The inventors have made investigations, and as a result, have found that in an electrophotographic apparatus including: an electrophotographic photosensitive member; and an intermediate transfer belt that is allowed to be brought into abutment against the electrophotographic photosensitive member, wherein the electrophotographic photosensitive member includes a surface layer containing polytetrafluoroethylene particles, a binding material, and a polymer A including a structural unit having a perfluoroalkyl group, wherein the intermediate transfer belt includes a surface layer containing a perfluoropolyether, a binding material, and a polymer B including a structural unit having a perfluoroalkyl group, wherein the polymer A includes a structural unit represented by the formula (1) as the structural unit having a perfluoroalkyl group, and wherein the polymer B includes a structural unit represented by the formula (2) as the structural unit having a perfluoroalkyl group, the occurrence of an image defect is suppressed, the image defect being caused by exudation of the perfluoropolyether from the intermediate transfer belt to the surface of the electrophotographic photosensitive member, which occurs at the time of printing after long-term suspension under a state in which the electrophotographic photosensitive member and the intermediate transfer belt are brought into abutment against each other.

This is conceivably because the perfluoropolyether dispersed in the surface layer of the intermediate transfer belt has higher affinity for the polymer B including a structural unit having an acrylic group as a polymerizable functional group as represented by the formula (2) as compared to the polymer A including a structure unit having a methacrylic group as a polymerizable functional group as represented by the formula (1), and hence the migration of the perfluoropolyether to the surface of the electrophotographic photosensitive member having the polymer A dispersed therein, against which the intermediate transfer belt is brought into abutment, is suppressed as compared to the case in which the electrophotographic photosensitive member and the intermediate transfer member each produced by using the same polymer are used in combination.

### <Polytetrafluoroethylene Particles Serving as Fluorine Atom-Containing Resin Particles>

The surface layer of the electrophotographic photosensitive member to be used in the electrophotographic apparatus of the present disclosure contains polytetrafluoroethylene particles as fluorine atom-containing resin particles. The content of the polytetrafluoroethylene particles in the surface layer is preferably 5 mass % or more to 40 mass % or less with respect to the total mass of the surface layer.

In the observation of a cross-section of the surface layer, the polytetrafluoroethylene particles preferably have an average primary particle diameter of 150 nm or more to 300 nm or less, which is an arithmetic average of long diameters of primary particles measured from a secondary electron image of the particles obtained with a scanning electron microscope, from the viewpoints of improving the dispersibility of the particles and suppressing a potential fluctuation. Further, the average primary particle diameter of the polytetrafluoroethylene particles is more preferably 180 nm or more to 250 nm or less.

The polytetrafluoroethylene particles preferably have an average of circularities (average circularity) of 0.75 or more, which is calculated from areas and perimeters of primary particles measured from a secondary electron image of the particles obtained with a scanning electron microscope.

To cause the measured values of the average primary particle diameter and average circularity of the polytetrafluoroethylene particles in the surface layer of the electrophotographic photosensitive member of the present disclosure to fall within the above-mentioned ranges, such polytetrafluoroethylene particles that the values of their average primary particle diameter and average circularity measured and calculated by the following methods fall within the ranges only need to be used.

### (Methods of Measuring Average Primary Particle Diameter and Average Circularity)

That is, in each of Examples of the present disclosure, the average primary particle diameter and average circularity of polytetrafluoroethylene particles to be incorporated into the surface layer of an electrophotographic photosensitive member were measured with a field emission scanning electron microscope (FE-SEM) as described below. The polytetrafluoroethylene particles were caused to adhere to a commercial carbon electroconductive tape, and the polytetrafluoroethylene particles that did not adhere to the electroconductive tape were removed with compressed air, followed by the deposition of platinum from the vapor onto the remaining particles. The polytetrafluoroethylene particles having deposited thereonto platinum were observed with a FE-SEM (S-4700) manufactured by Hitachi High-Technologies Corporation. Conditions for the measurement with the FE-SEM are as described below.
Acceleration voltage: 2 kV
WD: 5 mm
Magnification: 20,000
Number of pixels: 1,280 pixels in a longitudinal direction and 960 pixels in a lateral direction (size per pixel: 5 nm)

The Feret diameters of 100 particles were determined from the resultant image with ImageJ (open source software manufactured by the National Institutes of Health (NIH)), and their average was calculated and used as the average primary particle diameter.

In addition, the areas and perimeters of the particles were similarly determined, and the circularities thereof were determined from the following equation (II). The average of the circularities was calculated and used as the average circularity of the particles.

$$Circularity = 4 \times π \times ( area ) / ( square of perimeter ) \qquad Equation ( II )$$

The polytetrafluoroethylene particles of the present disclosure may be used alone or in combination thereof.

### <Polymer A Including Structural Unit Represented by Formula (1) and Polymer B Including Structural Unit Represented by Formula (2)>

The surface layer of the electrophotographic photosensitive member included in the electrophotographic apparatus of the present disclosure contains a polymer A including a structural unit having a perfluoroalkyl group, and the polymer A includes a structural unit represented by the following formula (1) as the structural unit having a perfluoroalkyl group:

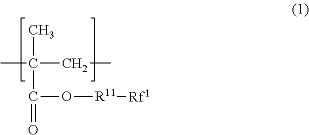

in the formula (1), R¹¹ represents a single bond or an alkylene group having 1 or more to 3 or less carbon atoms, and Rf¹ represents a perfluoroalkyl group having 1 or more to 5 or less carbon atoms;

The intermediate transfer belt included in the electrophotographic apparatus of the present disclosure includes a surface layer containing a polymer B including a structural unit having a perfluoroalkyl group, and the polymer B includes a structural unit represented by the following formula (2) as the structural unit having a perfluoroalkyl group:

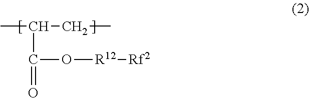

in the formula (2), R¹² represents a single bond or an alkylene group having 1 or more to 3 or less carbon atoms, and Rf² represents a perfluoroalkyl group having 1 or more to 5 or less carbon atoms.

When the number of carbon atoms of each of Rf¹ in the formula (1) and Rf² in the formula (2) is set to 6 or more, the affinity between the polymer A in the electrophotographic photosensitive member and the perfluoropolyether in the intermediate transfer belt is increased, and hence the exudation of the perfluoropolyether from the intermediate transfer belt to the electrophotographic photosensitive member cannot be sufficiently suppressed. Thus, it is preferred that Rf¹ in the formula (1) and Rf² in the formula (2) each represent a perfluoroalkyl group having 2 or more to 4 or less carbon atoms from the viewpoint of achieving both the dispersibility and the suppression of migration of the perfluoropolyether in the intermediate transfer belt from the intermediate transfer belt to the surface of the electrophotographic photosensitive member. Examples of the structures of Rf¹ and Rf² include structures shown below.

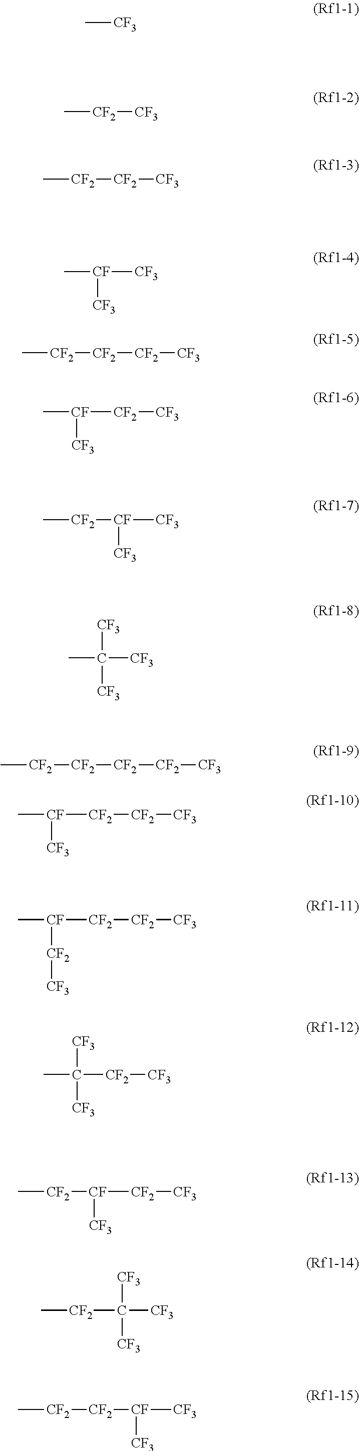

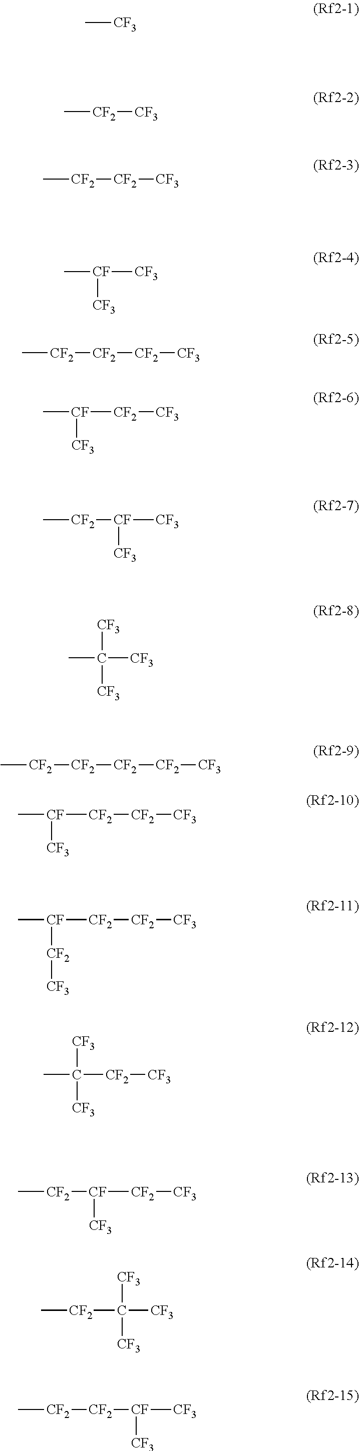

Examples of the structural unit represented by the formula (1) to be incorporated into the polymer A including the structural unit represented by the formula (1) to be used in the present disclosure include structures shown in Table 1 below.

TABLE 1
Number of

| Exemplified | Unit structure represented by formula (1) | |
|---|---|---|
| Compound | R¹¹ | Rf¹ |
| (1-1) | Single bond | —CF₃ |
| (1-2) | —CH₂— | —CF₃ |
| (1-3) | —CH₂—CH₂— | —CF₃ |
| (1-4) | —CH₂—CH₂—CH₂— | —CF₃ |
| (1-5) | Single bond | —CF₂—CF₃ |
| (1-6) | —CH₂— | —CF₂—CF₃ |
| (1-7) | —CH₂—CH₂— | —CF₂—CF₃ |
| (1-8) | —CH₂—CH₂—CH₂— | —CF₂—CF₃ |
| (1-9) | Single bond | —CF₂—CF₂—CF₃ |
| (1-10) | —CH₂— | —CF₂—CF₂—CF₃ |
| (1-11) | —CH₂—CH₂— | —CF₂—CF₂—CF₃ |
| (1-12) | —CH₂—CH₂—CH₂— | —CF₂—CF₂—CF₃ |
| (1-13) | Single bond | —CF₂—CF₂—CF₂—CF₃ |
| (1-14) | —CH₂— | —CF₂—CF₂—CF₂—CF₃ |
| (1-15) | —CH₂—CH₂— | —CF₂—CF₂—CF₂—CF₃ |
| (1-16) | —CH₂—CH₂—CH₂— | —CF₂—CF₂—CF₂—CF₃ |
| (1-17) | Single bond | —CF₂—CF₂—CF₂—CF₂—CF₃ |
| (1-18) | —CH₂— | —CF₂—CF₂—CF₂—CF₂—CF₃ |
| (1-19) | —CH₂—CH₂— | —CF₂—CF₂—CF₂—CF₂—CF₃ |
| (1-20) | —CH₂—CH₂—CH₂— | —CF₂—CF₂—CF₂—CF₂—CF₃ |

Examples of the structural unit represented by the formula (2) to be incorporated into the polymer B including the structural unit represented by the formula (2) to be used in the present disclosure include structures shown in Table 2 below.

TABLE 2
Number of

| Exemplified | Unit structure represented by formula (2) | |
|---|---|---|
| Compound | R¹² | Rf² |
| (2-1) | Single bond | —CF₃ |
| (2-2) | —CH₂— | —CF₃ |
| (2-3) | —CH₂—CH₂— | —CF₃ |
| (2-4) | —CH₂—CH₂—CH₂— | —CF₃ |
| (2-5) | Single bond | —CF₂—CF₃ |
| (2-6) | —CH₂— | —CF₂—CF₃ |
| (2-7) | —CH₂—CH₂— | —CF₂—CF₃ |
| (2-8) | —CH₂—CH₂—CH₂— | —CF₂—CF₃ |
| (2-9) | Single bond | —CF₂—CF₂—CF₃ |
| (2-10) | —CH₂— | —CF₂—CF₂—CF₃ |
| (2-11) | —CH₂—CH₂— | —CF₂—CF₂—CF₃ |
| (2-12) | —CH₂—CH₂—CH₂— | —CF₂—CF₂—CF₃ |
| (2-13) | Single bond | —CF₂—CF₂—CF₂—CF₃ |
| (2-14) | —CH₂— | —CF₂—CF₂—CF₂—CF₃ |
| (2-15) | —CH₂—CH₂— | —CF₂—CF₂—CF₂—CF₃ |
| (2-16) | —CH₂—CH₂—CH₂— | —CF₂—CF₂—CF₂—CF₃ |
| (2-17) | Single bond | —CF₂—CF₂—CF₂—CF₂—CF₃ |
| (2-18) | —CH₂— | —CF₂—CF₂—CF₂—CF₂—CF₃ |
| (2-19) | —CH₂—CH₂— | —CF₂—CF₂—CF₂—CF₂—CF₃ |
| (2-20) | —CH₂—CH₂—CH₂— | —CF₂—CF₂—CF₂—CF₂—CF₃ |

When the number of carbon atoms of Rf¹ in the formula (1) included in the polymer A to be incorporated into the surface layer of the electrophotographic photosensitive member of the present disclosure is represented by NRf¹, and the number of carbon atoms of Rf² in the formula (2) included in the polymer B to be incorporated into the surface layer of the intermediate transfer belt of the present disclosure is represented by NRf², it is preferred that NRf¹≥NRf² be satisfied from the viewpoint of suppressing the exudation of the perfluoropolyether in the surface layer of the intermediate transfer belt to the surface of the electrophotographic photosensitive member.

From the viewpoint of suppressing the exudation of the perfluoropolyether in the surface layer of the intermediate transfer belt to the surface of the electrophotographic photosensitive member, it is preferred that, when the mass of the structural unit having a perfluoroalkyl group included in the polymer A to be incorporated into the surface layer of the electrophotographic photosensitive member of the present disclosure is represented by MTA, and the mass of the structural unit represented by the formula (1) included in the polymer A is represented by MIA, the following formula (i) be satisfied, and that, when the mass of the structural unit having a perfluoroalkyl group included in the polymer B to be incorporated into the surface layer of the intermediate transfer belt of the present disclosure is represented by MTB, and the mass of the structural unit represented by the formula (2) included in the polymer B is represented by M2B, the following formula (ii) be satisfied.

$$0.5 < M 1 A / MTA \leq 1. \qquad ( i )$$

$$0.5 < M 2 B / MTB \leq 1. \qquad ( ii )$$

Further, it is more preferred that the following formula (iii) be satisfied from the viewpoint of improving the dispersibility of the polytetrafluoroethylene particles in the surface layer of the electrophotographic photosensitive member, and it is more preferred that the following formula (iv) be satisfied from the viewpoint of improving the dispersibility of the perfluoropolyether in the surface layer of the intermediate transfer belt.

$$0.7 < M 1 A / MTA \leq 1. \qquad ( iii )$$

$$0.7 < M 2 B / MTB \leq 1. \qquad ( iv )$$

Further, it is most preferred that MIA/MTA=1.0 and M2B/MTB=1.0 be satisfied from the viewpoints of improving the dispersibility of the polytetrafluoroethylene particles in the surface layer of the electrophotographic photosensitive member, improving the dispersibility of the perfluoropolyether in the surface layer of the intermediate transfer belt, and suppressing the exudation of the perfluoropolyether in the surface layer of the intermediate transfer belt to the surface of the electrophotographic photosensitive member.

The content of the structural unit represented by the formula (1) in the polymer A to be incorporated into the surface layer of the electrophotographic photosensitive member of the present disclosure is preferably 5 number % or more to 50 number % or less with respect to all the structural units of the polymer A from the viewpoint of improving the dispersibility of the polytetrafluoroethylene particles. In addition, the content of the structural unit represented by the formula (1) is preferably 0.05 mass % or more to 14.1 mass % or less with respect to all the structural units of the polymer A. Further, the content of the structural unit represented by the formula (1) is more preferably 20 number % or more to 45 number % or less with respect to all the structural units of the polymer A. In addition, the content of the structural unit represented by the formula (1) is still more preferably 0.2 mass % or more to 11.9 mass % or less with respect to all the structural units of the polymer A.

The weight-average molecular weight of the polymer A including the structural unit represented by the formula (1) to be incorporated into the surface layer of the electrophotographic photosensitive member of the present disclosure is preferably 16,000 or more to 300,000 or less from the viewpoints of improving the dispersibility of the polytetrafluoroethylene particles and suppressing a potential fluctuation at the time of repeated use. Further, the weight-average molecular weight of the polymer A including the structural unit represented by the formula (1) is more preferably 40,000 or more to 250,000 or less.

The weight-average molecular weight of the polymer A including the structural unit represented by the formula (1) may be measured and calculated by the following method.

### (Measurement of Weight-Average Molecular Weight by GPC)

The weight-average molecular weight according to the present disclosure is measured by gel permeation chromatography (GPC) as described below.

First, a sample is dissolved in tetrahydrofuran (THF) at room temperature over 24 hours. Then, the resultant solution is filtered with a solvent-resistant membrane filter “Myshoridisk” (manufactured by Tosoh Corporation) having a pore diameter of 0.2 μm to provide a sample solution. The concentration of a THF-soluble component in the sample solution is adjusted to about 0.8 mass %. Measurement is performed with the sample solution under the following conditions.
Apparatus: HLC 8120 GPC (detector: RI) (manufactured by Tosoh Corporation)
Column: Septuplicate of Shodex KF-801, 802, 803, 804, 805, 806, and 807 (manufactured by Showa Denko K.K.)
Eluent: Tetrahydrofuran (THF)
Flow rate: 1.0 ml/min
Oven temperature: 40.0° C.
Sample injection amount: 0.10 ml

At the time of the calculation of the molecular weight of the sample, a molecular weight calibration curve prepared with standard polystyrene resins (e.g., products available under the product names “TSK Standard Polystyrenes F-850, F-450, F-288, F-128, F-80, F-40, F-20, F-10, F-4, F-2, F-1, A-5000, A-2500, A-1000, and A-500” from Tosoh Corporation) is used.

The content of the polymer A including the structural unit represented by the formula (1) with respect to the polytetrafluoroethylene particles in the surface layer of the electrophotographic photosensitive member of the present disclosure is preferably 2 mass % or more to 10 mass % or less, more preferably 4 mass % or more to 8 mass % or less from the viewpoint of improving the dispersibility of the particles and suppressing a potential fluctuation at the time of repeated use.

The polymer A is preferably a polymer including the structural unit represented by the formula (1) and a structural unit represented by the following formula (M). The polymer B is preferably a polymer including the structural unit represented by the formula (2) and the structural unit represented by the following formula (M). The polymer A more preferably includes, as its structural units, only the structural unit represented by the formula (1) and the structural unit represented by the formula (M):

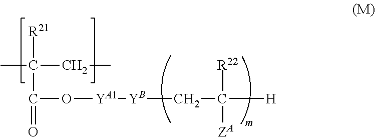

in the formula (M), Y^{A1} represents an unsubstituted alkylene group, Y^{B} represents an unsubstituted alkylene group, an alkylene group substituted with a halogen atom, an alkylene group substituted with a hydroxy group, an ester bond (—COO—), an amide bond (—NHCO—), or a urethane bond (—NHCOO—), or a divalent linking group that may be derived by combining one or more kinds of these groups or bonds, and —O— or —S—, or a single bond, Z^{A} represents a structure represented by the formula (2A), a cyano group, or a phenyl group, R²¹ and R²² each independently represent a hydrogen atom or a methyl group, and “m” represents an integer of 25 or more to 150 or less;

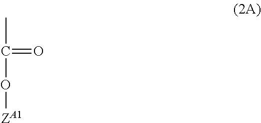

in the formula (2A), Z^{A1} represents an alkyl group having 1 or more to 4 or less carbon atoms.

When Y^{B} in the formula (M) represents an ester bond, —Y^{A1}—Y^{B}—CH₂— may be any one of —Y^{A1}—CO—O—CH₂— and —Y^{A1}—O—CO—CH₂—, and is preferably —Y^{A1}—CO—O—CH₂—. In addition, when Y^{B} in the formula (M) represents an amide bond, —Y^{A1}—Y^{B}—CH₂— may be any one of —Y^{A1}—NH—CO—CH₂— and —Y^{A1}—CO—NH—CH₂—, and is preferably —Y^{A1}—NH—CO—CH₂—. In addition, when Y^{B} in the formula (2) represents a urethane bond, —Y^{A1}—Y^{B}—CH₂— may be any one of —Y^{A1}—NH—CO—O—CH₂— and —Y^{A1}—O—CO—NH—CH₂—, and is preferably —Y^{A1}—NH—CO—O—CH₂—.

In addition, —Y^{A1}—Y^{B}— in the formula (M) preferably has a structure represented by —Y^{A1}—(Y^{A2})_{b}—(Y^{A3})_{c}—(Y^{A4})_{d}—(Y^{A5})ₑ—(Y^{A6})_{f}— where Y^{A1} represents an unsubstituted alkylene group, Y^{A2} represents a methylene group substituted with at least one selected from the group consisting of: a hydroxy group; and a halogen atom, Y^{A3} represents an unsubstituted alkylene group, Y^{A4} represents an ester bond, an amide bond, or a urethane bond, Y^{A5} represents an unsubstituted alkylene group, Y^{A6} represents an oxygen atom or a sulfur atom, and “b”, “c”, “d”, “e”, and “f” each independently represent 0 or 1.

It is preferred that

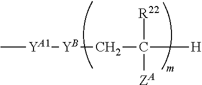

in the formula (M) be not an acidic group having a pKa of 3 or less.

It is preferred that

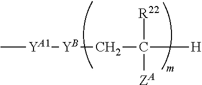

in the formula (M) be not —SO₃H.

In the polymer A including the structural unit represented by the formula (1) and the structural unit represented by the formula (M), a ratio between the structural unit represented by the formula (1) and the structural unit represented by the formula (M) is preferably 1:19 to 1:1, more preferably 1:4 to 9:11 in terms of molar ratio.

In the polymer B including the structural unit represented by the formula (2) and the structural unit represented by the formula (M), a ratio between the structural unit represented by the formula (2) and the structural unit represented by the formula (M) is preferably 1:19 to 1:1, more preferably 1:4 to 9:11 in terms of molar ratio.

Examples of the structural unit represented by the formula (M) include structures shown in Table 3 below.

TABLE 3

| | Structural unit represented by formula (M) | | | | | | |
|---|---|---|---|---|---|---|---|
| Number | R²¹ | R²² | Y^{A1} | Y^{B} | Z^{A} | Z^{A1} | m |
| u2-1 | —CH₃ | —CH₃ | —CH₂— | 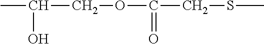 | Formula (2A) | —CH₃ | 60 |
| u2-2 | —CH₃ | —CH₃ | —CH₂— | 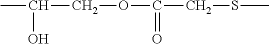 | Formula (2A) | —CH₃ | 25 |
| u2-3 | —CH₃ | —CH₃ | —CH₂— | 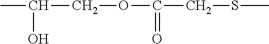 | Formula (2A) | —CH₃ | 150 |
| u2-4 | —CH₃ | —H | —CH₂— | 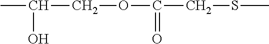 | Formula (2A) | —CH₃ | 60 |
| u2-5 | —H | —CH₃ | —CH₂— | 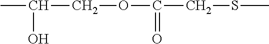 | Formula (2A) | —CH₃ | 60 |
| u2-6 | —H | —H | —CH₂— | 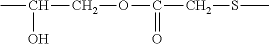 | Formula (2A) | —CH₃ | 60 |
| u2-7 | —CH₃ | —CH₃ | —CH₂—CH₂— | 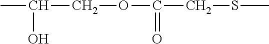 | Formula (2A) | —CH₃ | 60 |
| u2-8 | —CH₃ | —CH₃ | —CH₂— | 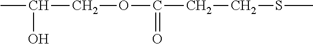 | Formula (2A) | —CH₃ | 60 |
| u2-9 | —CH₃ | —CH₃ | —CH₂—CH₂— | 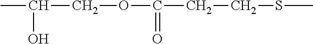 | Formula (2A) | —CH₃ | 60 |
| u2-10 | —CH₃ | —CH₃ | —CH₂— | 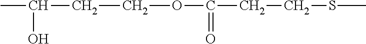 | Formula (2A) | —CH₃ | 60 |
| u2-11 | —CH₃ | —CH₃ | —CH₂—CH₂— | 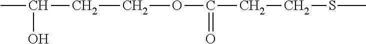 | Formula (2A) | —CH₃ | 60 |
| u2-12 | —CH₃ | —CH₃ | —CH₂— | 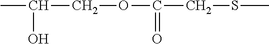 | Formula (2A) | —CH₂—CH₃ | 60 |
| u2-13 | —CH₃ | —CH₃ | —CH₂— | 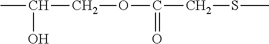 | Formula (2A) | —CH₂CH₂CH₂CH₃ | 60 |
| u2-14 | —CH₃ | —H | —CH₂— | 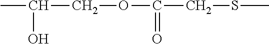 | Formula (2A) | —CH₂CH₂CH₂CH₃ | 60 |
| u2-15 | —CH₃ | —CH₃ | —CH₂— | 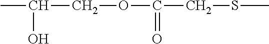 | Formula (2A) | —CH₂CH(CH₃)₂ | 60 |
| u2-16 | —CH₃ | —H | —CH₂— | 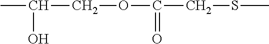 | Formula (2A) | —CH₂CH(CH₃)₂ | 60 |
| u2-17 | —CH₃ | —CH₃ | —CH₂— | 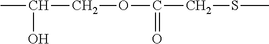 | Formula (2A) | —C(CH₃)₃ | 60 |
| u2-18 | —CH₃ | —H | —CH₂— | 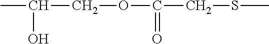 | Formula (2A) | —C(CH₃)₃ | 60 |
| u2-19 | —CH₃ | —H | —CH₂— | 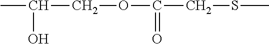 | Phenyl group | — | 60 |
| u2-20 | —CH₃ | —H | —CH₂— | 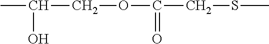 | Cyano group | — | 60 |
| u2-21 | —CH₃ | —CH₃ | —CH₂—CH₂— | 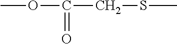 | Formula (2A) | —CH₃ | 60 |
| u2-22 | —CH₃ | —CH₃ | —CH₂—CH₂— | 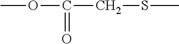 | Formula (2A) | —CH₃ | 60 |
| u2-23 | —H | —CH₃ | —CH₂—CH₂— | 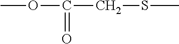 | Formula (2A) | —CH₃ | 60 |
| u2-24 | —CH₃ | —CH₃ | —CH₂— | 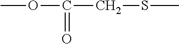 | Formula (2A) | —CH₃ | 60 |
| u2-25 | —CH₃ | —CH₃ | —CH₂CH₂CH₂CH₂— | 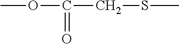 | Formula (2A) | —CH₃ | 60 |
| u2-26 | —CH₃ | —CH₃ | —CH₂—CH₂— | 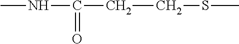 | Formula (2A) | —CH₃ | 60 |
| u2-27 | —H | —CH₃ | —CH₂—CH₂— | 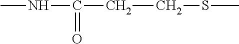 | Formula (2A) | —CH₃ | 60 |
| u2-28 | —CH₃ | —CH₃ | —CH₂—CH₂— | 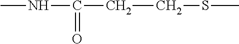 | Formula (2A) | —CH₃ | 60 |
| u2-29 | —CH₃ | —CH₃ | —CH₂—CH₂— | 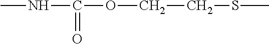 | Formula (2A) | —CH₃ | 60 |
| u2-30 | —H | —CH₃ | —CH₂—CH₂— | 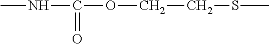 | Formula (2A) | —CH₃ | 60 |
| u2-31 | —CH₃ | —CH₃ | —CH₂—CH₂— | 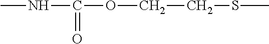 | Formula (2A) | —CH₃ | 60 |
| u2-32 | —CH₃ | —H | —CH₂—CH₂— | 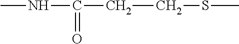 | Formula (2A) | —CH₃ | 60 |
| u2-33 | —H | —H | —CH₂—CH₂— | 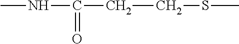 | Formula (2A) | —CH₃ | 60 |
| u2-34 | —CH₃ | —H | —CH₂—CH₂— | 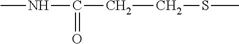 | Formula (2A) | —CH₃ | 60 |
| u2-35 | —CH₃ | —H | —CH₂—CH₂— | 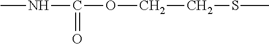 | Formula (2A) | —CH₃ | 60 |
| u2-36 | —H | —H | —CH₂—CH₂— | 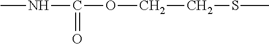 | Formula (2A) | —CH₃ | 60 |
| u2-37 | —CH₃ | —H | —CH₂—CH₂— | 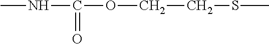 | Formula (2A) | —CH₃ | 60 |

The polymer B to be incorporated into the surface layer of the intermediate transfer belt of the present disclosure functions as a dispersant for dispersing a perfluoropolyether (PFPE) in a binder resin. The polymer B has a number-average molecular weight Mn within the range of 11,000 or more to 15,000 or less and a peak top molecular weight Mp within the range of 24,000 or more to 40,000 or less in order to disperse the PFPE in the binder resin.

Polymer B can exhibit a high steric hindrance effect to effectively suppress the aggregation of a PFPE and another PFPE by having a number-average molecular weight and a peak top molecular weight within the above-mentioned numerical ranges. As a result, the domain size of the PFPE in the binder resin can be set to, for example, such a small size that an average long diameter is 1 nm or more to 60 nm or less, and a decrease in glossiness of the surface of the electrophotographic belt such as the intermediate transfer belt can be prevented. In addition, the dispersant can prevent the encounter probability between the dispersant and the PFPE from becoming too low by having a number-average molecular weight and a peak top molecular weight within the above-mentioned numerical ranges. As a result, the aggregation of a PFPE and another PFPE can be suppressed, and an increase in domain size can be suppressed. As a result, a decrease in glossiness of the surface of the intermediate transfer belt can be prevented.

Here, the number-average molecular weight and the peak top molecular weight are measured with a GPC apparatus.

Specifically, the above-mentioned dispersant is dissolved in tetrahydrofuran. The dissolved solution is injected into a column (product name; TSK-GEL MULTIPORE HXL-M; manufactured by Tosoh Corporation) and is passed through the column at a certain constant flow rate. An elution time distribution is measured with a gel permeation chromatography apparatus (HLC-8220, manufactured by Tosoh Corporation) that elutes components adsorbed to the column, and a molecular weight distribution is calculated from the results through use of a calibration curve prepared in advance from a polystyrene standard sample having a known molecular weight. The number-average molecular weight is calculated from the results. The peak top molecular weight was set to a mode value in the number-average molecular weight distribution.

The polymer A including the structural unit having a perfluoroalkyl group and the polymer B including the structural unit having a perfluoroalkyl group according to this aspect each having a number-average molecular weight and a peak top molecular weight within predetermined numerical ranges may be prepared by the following method.

That is, the dispersant according to this aspect may be prepared by using a preparative HPLC apparatus (product name: LC-908; manufactured by Japan Analytical Industry Co., Ltd.). For example, any of columns “JAIGEL-1H”, “JAIGEL-2H”, “JAIGEL-3H”, “JAIGEL-4H”, and “JAIGEL-5H” (product names; manufactured by Japan Analytical Industry Co., Ltd., 20 mm×600 mm in diameter: preparative columns) may be used as a column. Specifically, the polymer including the structural unit having a perfluoroalkyl group according to this aspect is injected into the column, and a solution is collected at each elution time to provide dispersants having different molecular weight distributions.

Each of the solutions is measured for a molecular weight distribution with the GPC apparatus described above. From the separation solutions each having a molecular weight distribution measured, a dispersant having a desired peak top molecular weight Mp is selected. When the number-average molecular weight of the separation solution having a peak top molecular weight Mp specified is larger than the desired number-average molecular weight Mn, the separation solution is mixed with a separation solution having a lower molecular weight. Thus, the number-average molecular weight Mn can be reduced while the peak top molecular weight Mp remains unchanged. When the number-average molecular weight of the separation solution is smaller than the desired number-average molecular weight Mn, the separation solution is mixed with a separation solution having a higher molecular weight. Thus, the number-average molecular weight Mn can be increased while the peak top molecular weight Mp remains unchanged.

Thus, the polymer A and the polymer B according to this aspect can be obtained.

The content of the polymer B in the intermediate transfer belt of the present disclosure is preferably 5 mass % or more to 30 mass % or less, more preferably 15 mass % or more to 25 mass % or less with respect to the mass of the total solid content of the surface layer.

### <Electrophotographic Photosensitive Member>

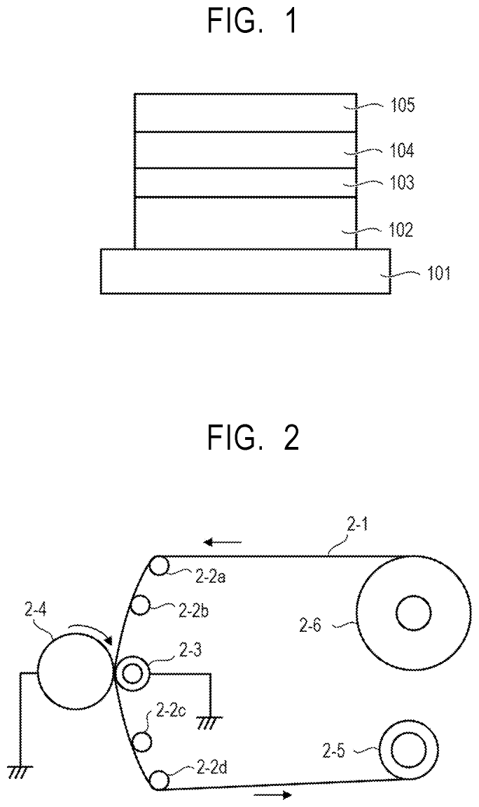

An example of the layer configuration of the electrophotographic photosensitive member to be used in the electrophotographic apparatus of the present disclosure is illustrated in FIG. 1. In FIG. 1, an undercoat layer 102, a charge-generating layer 103, a charge-transporting layer 104, and a surface layer 105 are laminated on a support 101. A photosensitive layer may include a laminate type photosensitive layer including the charge-generating layer and the charge-transporting layer, or may include a monolayer type photosensitive layer containing a charge-generating substance and a charge-transporting substance.

The surface layer of the electrophotographic photosensitive member of the present disclosure contains the polytetrafluoroethylene particles, the binding material, and the polymer A including the structural unit represented by the formula (1).

As a method of producing the electrophotographic photosensitive member to be used in the electrophotographic apparatus of the present disclosure, there is given a method including preparing coating liquids for respective layers to be described later, sequentially applying coating liquids for desired layers, and drying the coating liquids. In this case, as a method of applying the coating liquids, there are given, for example, dip coating, spray coating, inkjet coating, roll coating, die coating, blade coating, curtain coating, wire bar coating, and ring coating. Of those, dip coating is preferred from the viewpoints of efficiency and productivity.

The configuration of the electrophotographic photosensitive member to be used in the electrophotographic apparatus of the present disclosure is described below.

### <Support>

The support of the electrophotographic photosensitive member is preferably a support having electroconductivity (electroconductive support). In addition, examples of the shape of the support include a cylindrical shape, a belt shape, and a sheet shape. Of those, a cylindrical support is preferred. In addition, the surface of the support may be subjected to, for example, electrochemical treatment such as anodization, blast treatment, or cutting treatment.

A metal, a resin, glass, or the like is preferred as a material for the support.

Examples of the metal include aluminum, iron, nickel, copper, gold, stainless steel, and alloys thereof. Of those, an aluminum support using aluminum is preferred.

In addition, electroconductivity is preferably imparted to the resin or the glass through treatment including, for example, mixing or coating the resin or the glass with an electroconductive material.

### <Electroconductive Layer>

An electroconductive layer may be arranged on the support. The arrangement of the electroconductive layer can conceal flaws and unevenness in the surface of the support, and control the reflection of light on the surface of the support.

The electroconductive layer preferably contains electroconductive particles and a resin.

A material for the electroconductive particles is, for example, a metal oxide, a metal, or carbon black.

Examples of the metal oxide include zinc oxide, aluminum oxide, indium oxide, silicon oxide, zirconium oxide, tin oxide, titanium oxide, strontium titanate, magnesium oxide, antimony oxide, and bismuth oxide. Examples of the metal include aluminum, nickel, iron, nichrome, copper, zinc, and silver.

Of those, metal oxide particles are preferably used as the electroconductive particles, and in particular, titanium oxide particles, tin oxide particles, and zinc oxide particles are more preferably used.

When the metal oxide particles are used as the electroconductive particles, the surface of each of the metal oxide particles may be treated with a silane coupling agent or the like, or the metal oxide particles may each be doped with an element, such as phosphorus or aluminum, or an oxide thereof.

In addition, the electroconductive particles may each have a laminated construction including a core particle and a coating layer coating the particle. Examples of the core particle include titanium oxide particles, barium sulfate particles, and zinc oxide particles. The coating layer is, for example, metal oxide particles such as tin oxide.

In addition, when the metal oxide particles are used as the electroconductive particles, their volume-average particle diameter is preferably 1 nm or more to 500 nm or less, more preferably 3 nm or more to 400 nm or less.

Examples of the resin include a polyester resin, a polycarbonate resin, a polyvinyl acetal resin, an acrylic resin, a silicone resin, an epoxy resin, a melamine resin, a polyurethane resin, a phenol resin, and an alkyd resin.

In addition, the electroconductive layer may further contain, for example, a concealing agent, such as a silicone oil, resin particles, or titanium oxide.

The electroconductive layer may be formed by: preparing a coating liquid for an electroconductive layer containing the above-mentioned materials and a solvent; forming a coating film thereof on the support; and drying the coating film. Examples of the solvent to be used for the coating liquid for an electroconductive layer include an alcohol-based solvent, a sulfoxide-based solvent, a ketone-based solvent, an ether-based solvent, an ester-based solvent, and an aromatic hydrocarbon-based solvent. A dispersion method for dispersing the electroconductive particles in the coating liquid for an electroconductive layer is, for example, a method including using a paint shaker, a sand mill, a ball mill, or a liquid collision type high-speed disperser.

The thickness of the electroconductive layer is preferably 1 μm or more to 50 μm or less, particularly preferably 3 μm or more to 40 μm or less.

### <Undercoat Layer>

In the present disclosure, an undercoat layer may be arranged on the support or the electroconductive layer. The arrangement of the undercoat layer can improve an adhesive function between layers to impart a charge injection-inhibiting function.

The undercoat layer preferably contains a resin. In addition, the undercoat layer may be formed as a cured film by polymerizing a composition containing a monomer having a polymerizable functional group.

Examples of the resin include a polyester resin, a polycarbonate resin, a polyvinyl acetal resin, an acrylic resin, an epoxy resin, a melamine resin, a polyurethane resin, a phenol resin, a polyvinyl phenol resin, an alkyd resin, a polyvinyl alcohol resin, a polyethylene oxide resin, a polypropylene oxide resin, a polyamide resin, a polyamic acid resin, a polyimide resin, a polyamide imide resin, and a cellulose resin.

Examples of the polymerizable functional group of the monomer having a polymerizable functional group include an isocyanate group, a blocked isocyanate group, a methylol group, an alkylated methylol group, an epoxy group, a metal alkoxyl group, a hydroxy group, an amino group, a carboxy group, a thiol group, a carboxylic acid anhydride group, and a carbon-carbon double bond group.

In addition, the undercoat layer may further contain an electron-transporting substance, metal oxide particles, metal particles, an electroconductive polymer, and the like for the purpose of improving electric characteristics. Of those, an electron-transporting substance and metal oxide particles are preferably used.

Examples of the electron-transporting substance include a quinone compound, an imide compound, a benzimidazole compound, a cyclopentadienylidene compound, a fluorenone compound, a xanthone compound, a benzophenone compound, a cyanovinyl compound, a halogenated aryl compound, a silole compound, and a boron-containing compound. An electron-transporting substance having a polymerizable functional group may be used as the electron-transporting substance and copolymerized with the above-mentioned monomer having a polymerizable functional group to form the undercoat layer as a cured film.

Examples of the metal oxide particles include particles of indium tin oxide, tin oxide, indium oxide, titanium oxide, strontium titanate, zinc oxide, and aluminum oxide. Particles of silicon dioxide may also be used. Examples of the metal particles include particles of gold, silver, and aluminum.

The metal oxide particles to be incorporated into the undercoat layer may be subjected to surface treatment with a surface treatment agent such as a silane coupling agent before use.

A general method is used as a method of subjecting the metal oxide particles to the surface treatment. Examples thereof include a dry method and a wet method.

The dry method includes, while stirring the metal oxide particles in a mixer capable of high-speed stirring such as a Henschel mixer, adding an alcoholic aqueous solution, organic solvent solution, or aqueous solution containing the surface treatment agent, uniformly dispersing the mixture, and then drying the dispersion.

In addition, the wet method includes stirring the metal oxide particles and the surface treatment agent in a solvent, or dispersing the metal oxide particles and the surface treatment agent in a solvent with a sand mill or the like using glass beads or the like. After the dispersion, the solvent is removed by filtration or evaporation under reduced pressure. After the removal of the solvent, it is preferred to further perform baking at 100° C. or more.

The undercoat layer may further contain an additive, and for example, may contain a known material, such as: metal particles such as aluminum particles; electroconductive particles such as carbon black; a charge-transporting substance; a metal chelate compound; or an organometallic compound.

The undercoat layer may be formed by: preparing a coating liquid for an undercoat layer containing the above-mentioned materials and a solvent; forming a coating film thereof on the support or the electroconductive layer; and drying and/or curing the coating film.

Examples of the solvent to be used for the coating liquid for an undercoat layer include organic solvents, such as an alcohol, a sulfoxide, a ketone, an ether, an ester, an aliphatic halogenated hydrocarbon, and an aromatic compound. In the present disclosure, alcohol-based and ketone-based solvents are preferably used.

A dispersion method for preparing the coating liquid for an undercoat layer is, for example, a method including using a homogenizer, an ultrasonic disperser, a ball mill, a sand mill, a roll mill, a vibration mill, an attritor, or a liquid collision type high-speed disperser.

The thickness of the undercoat layer is preferably 0.1 μm or more, more preferably 0.2 μm or more, particularly preferably 0.3 μm or more. In addition, the thickness of the undercoat layer is preferably 50 μm or less, more preferably 40 μm or less, still more preferably 30 μm or less, still more preferably 10 μm or less, particularly preferably 5 μm or less.

### <Photosensitive Layer>

The photosensitive layers of the electrophotographic photosensitive member are mainly classified into (1) a laminate type photosensitive layer and (2) a monolayer type photosensitive layer. (1) The laminate type photosensitive layer is a photosensitive layer having a charge-generating layer containing a charge-generating substance and a charge-transporting layer containing a charge-transporting substance. (2) The monolayer type photosensitive layer is a photosensitive layer containing both a charge-generating substance and a charge-transporting substance.

### (1) Laminate Type Photosensitive Layer

The laminate type photosensitive layer has the charge-generating layer and the charge-transporting layer.

### (1-1) Charge-Generating Layer

The charge-generating layer preferably contains the charge-generating substance and a resin.

Examples of the charge-generating substance include azo pigments, perylene pigments, polycyclic quinone pigments, indigo pigments, and phthalocyanine pigments. Of those, azo pigments and phthalocyanine pigments are preferred. Of the phthalocyanine pigments, an oxytitanium phthalocyanine pigment, a chlorogallium phthalocyanine pigment, and a hydroxygallium phthalocyanine pigment are preferred.

The content of the charge-generating substance in the charge-generating layer is preferably 40 mass % or more to 85 mass % or less, more preferably 60 mass % or more to 80 mass % or less with respect to the total mass of the charge-generating layer.

Examples of the resin include a polyester resin, a polycarbonate resin, a polyvinyl acetal resin, a polyvinyl butyral resin, an acrylic resin, a silicone resin, an epoxy resin, a melamine resin, a polyurethane resin, a phenol resin, a polyvinyl alcohol resin, a cellulose resin, a polystyrene resin, a polyvinyl acetate resin, and a polyvinyl chloride resin. Of those, a polyvinyl butyral resin is more preferred.

In addition, the charge-generating layer may further contain an additive, such as an antioxidant or a UV absorber. Specific examples thereof include a hindered phenol compound, a hindered amine compound, a sulfur compound, a phosphorus compound, and a benzophenone compound.

The charge-generating layer may be formed by: preparing a coating liquid for a charge-generating layer containing the above-mentioned materials and a solvent; forming a coating film thereof on the support, the electroconductive layer, or the undercoat layer; and drying the coating film. Examples of the solvent to be used for the coating liquid include an alcohol-based solvent, a sulfoxide-based solvent, a ketone-based solvent, an ether-based solvent, an ester-based solvent, and an aromatic hydrocarbon-based solvent.

The thickness of the charge-generating layer is preferably 0.1 μm or more to 1 μm or less, more preferably 0.15 μm or more to 0.4 μm or less.

### (1-2) Charge-Transporting Layer

The charge-transporting layer preferably contains the charge-transporting substance and a binding material.

In the case where a protective layer to be described later is not arranged, the charge-transporting layer serves as the surface layer of the electrophotographic photosensitive member. In this case, the charge-transporting layer contains the fluorine atom-containing resin particles, the binding material, and the polymer A including the structural unit represented by the formula (1).

Examples of the charge-transporting substance include a polycyclic aromatic compound, a heterocyclic compound, a hydrazone compound, a styryl compound, an enamine compound, a triarylamine compound, and a resin having a group derived from each of those substances. Of those, a triarylamine compound is preferred.

The content of the charge-transporting substance in the charge-transporting layer is preferably 25 mass % or more to 70 mass % or less, more preferably 30 mass % or more to 55 mass % or less with respect to the total mass of the charge-transporting layer.

A thermoplastic resin (hereinafter also referred to as “resin”) is used as the binding material.

Examples of the thermoplastic resin include a polyester resin, a polycarbonate resin, an acrylic resin, and a polystyrene resin. Of those, a polycarbonate resin and a polyester resin are preferred. A polyarylate resin is particularly preferred as the polyester resin.

A content ratio (mass ratio) between the charge-transporting substance and the resin is preferably 4:10 to 20:10, more preferably 5:10 to 12:10.

The content of the fluorine atom-containing resin particles in the charge-transporting layer is preferably 5 mass % or more to 20 mass % or less, more preferably 7 mass % or more to 10 mass % or less.

In addition, the charge-transporting layer may contain an additive, such as an antioxidant, a UV absorber, a plasticizer, or a leveling agent. Specific examples thereof include a hindered phenol compound, a hindered amine compound, a sulfur compound, a phosphorus compound, a benzophenone compound, a siloxane-modified resin, a silicone oil, polystyrene resin particles, polyethylene resin particles, and boron nitride particles.

The charge-transporting layer may be formed by: preparing a coating liquid for a charge-transporting layer containing the above-mentioned materials and a solvent; forming a coating film thereof on the charge-generating layer; and drying the coating film. Examples of the solvent to be used for the coating liquid include an alcohol-based solvent, a ketone-based solvent, an ether-based solvent, an ester-based solvent, and an aromatic hydrocarbon-based solvent. Of those solvents, an ether-based solvent or an aromatic hydrocarbon-based solvent is preferred.

The thickness of the charge-transporting layer is preferably 5 μm or more to 50 μm or less, more preferably 8 μm or more to 40 μm or less, particularly preferably 10 μm or more to 30 μm or less.

### (2) Monolayer Type Photosensitive Layer

The monolayer type photosensitive layer may be formed by: preparing a coating liquid for a photosensitive layer containing the charge-generating substance, the charge-transporting substance, a resin, and a solvent; forming a coating film thereof on the support, the electroconductive layer, or the undercoat layer; and drying the coating film. Examples of the charge-generating substance, the charge-transporting substance, and the resin are the same as those of the materials in the section “(1) Laminate Type Photosensitive Layer.”

### <Protective Layer>

In the present disclosure, a protective layer may be arranged on the photosensitive layer. The arrangement of the protective layer can improve durability.

In the case where the protective layer is not arranged, the charge-transporting layer or the photosensitive layer serves as the surface layer.

In the case where the protective layer is arranged, the protective layer serves as the surface layer of the electrophotographic photosensitive member. In this case, the protective layer contains the fluorine atom-containing resin particles, the binding material, and the polymer A including the structural unit represented by the formula (1).

The protective layer may be formed as a cured film by polymerizing, for example, a composition containing a monomer having a polymerizable functional group, the composition serving as a raw material for the binding material. A reaction at that time is, for example, a thermal polymerization reaction, a photopolymerization reaction, or a radiation polymerization reaction. Examples of the polymerizable functional group of the monomer having a polymerizable functional group include an isocyanate group, a blocked isocyanate group, a methylol group, an alkyl methylol group, an epoxy group, a metal alkoxyl group, a hydroxy group, an amino group, a carboxy group, a thiol group, a carboxylic acid anhydride group, and a group containing a carbon-carbon double bond. Examples of the group containing a carbon-carbon double bond include an acryloyl group and a methacryloyl group. A monomer having a charge-transporting ability may be used as the monomer having a polymerizable functional group.

Herein, the cured product of the monomer having a polymerizable functional group is the binding material of the protective layer. That is, in the present disclosure, the surface layer contains a binding material or at least any one selected from a binding material and a raw material for the binding material.

A hole-transportable compound having a chain-polymerizable functional group is preferably used as the monomer having a polymerizable functional group.

The hole-transportable compound having a chain-polymerizable functional group is preferably a compound represented by the following formula (CT-1) or (CT-2):

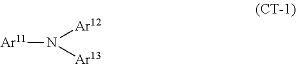

in the formula (CT-1), Ar¹¹ to Ar¹³ each independently represent a substituted aryl group or an unsubstituted aryl group, and a substituent that the substituted aryl group may have is an alkyl group having 1 or more to 6 or less carbon atoms, or a monovalent functional group represented by any one of the following formulae (P-1) to (P-3), provided that the compound represented by the formula (CT-1) has at least one monovalent functional group represented by any one of the following formulae (P-1) to (P-3);

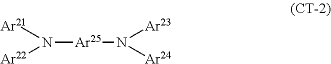

in the formula (CT-2), Ar²¹ to Ar²⁴ each independently represent a substituted aryl group or an unsubstituted aryl group, Ar²⁵ represents a substituted arylene group or an unsubstituted arylene group, a substituent that the substituted aryl group may have is an alkyl group having 1 or more to 6 or less carbon atoms, or a monovalent functional group represented by any one of the following formulae (P-1) to (P-3), and a substituent that the substituted arylene group may have is an alkyl group having 1 or more to 6 or less carbon atoms, or a monovalent functional group represented by any one of the following formulae (P-1) to (P-3), provided that the compound represented by the formula (CT-2) has at least one monovalent functional group represented by any one of the following formulae (P-1) to (P-3);

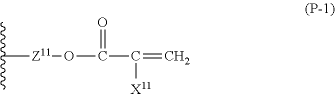

in the formula (P-1), Z¹¹ represents a single bond or an alkylene group having 1 or more to 6 or less carbon atoms, and X¹¹ represents a hydrogen atom or a methyl group;

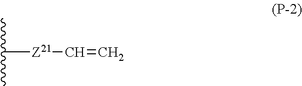

in the formula (P-2), Z²¹ represents a single bond or an alkylene group having 1 or more to 6 or less carbon atoms;

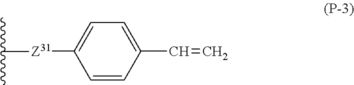

in the formula (P-3), Z³¹ represents a single bond or an alkylene group having 1 or more to 6 or less carbon atoms.

The content of the polytetrafluoroethylene particles in the protective layer is preferably 5 mass % or more to 40 mass % or less, more preferably 25 mass % or more to 35 mass % or less with respect to the total mass of the protective layer.

The protective layer preferably contains a compound represented by the following formula (3). In addition, at the time of the production of a coating liquid for a surface layer, the compound represented by the following formula (3) is preferably a liquid compound from the viewpoint that the compound is used as a dispersion medium.

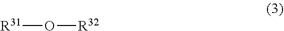

In the formula (3), R³¹ represents an alkyl group having 1 or more to 6 or less carbon atoms, or a fluoroalkyl group having 1 or more to 6 or less carbon atoms. R³² represents a fluoroalkyl group having 1 or more to 6 or less carbon atoms. R³¹ preferably represents a fluoroalkyl group having 1 or more to 6 or less carbon atoms.

Examples of the compound represented by the formula (3) include methyl nonafluorobutyl ether, ethyl nonafluorobutyl ether, 1,1,1,2,3,4,4,5,5,5-decafluoro-3-methoxy-2-(trifluoromethyl)pentane, and 1,1,2,2-tetrafluoroethyl-2,2,2-trifluoroethyl ether. Of those, 1,1,2,2-tetrafluoroethyl-2,2,2-trifluoroethyl ether is preferred from the viewpoints of improving the dispersibility of the particles and suppressing a potential fluctuation at the time of repeated use.

The content of the compound represented by the formula (3) in the protective layer is preferably 1 ppm or more to 10 ppm or less from the viewpoint of suppressing a potential fluctuation.

A method of measuring the content of the compound represented by the formula (3) in the protective layer is, for example, a method based on GCMS analysis. A film sample that is a product shaved from the surface layer on the electrophotographic photosensitive member with a razor or the like is used as a measurement sample. The content of the compound represented by the formula (3) in the surface layer may be measured by analyzing the measurement sample with a GCMS. For example, GCMS-QP2000 (manufactured by Shimadzu Corporation) may be utilized as an apparatus to be used in the GCMS analysis. Also in each of Examples of the present disclosure, a measurement sample was obtained by the above-mentioned method, and then the content of the compound represented by the formula (3) was measured with the above-mentioned GCMS apparatus.

The protective layer may contain an additive, such as an antioxidant, a UV absorber, a plasticizer, or a leveling agent. Specific examples thereof include a hindered phenol compound, a hindered amine compound, a sulfur compound, a phosphorus compound, a benzophenone compound, a siloxane-modified resin, and a silicone oil.

The protective layer may be formed by: preparing a coating liquid for a protective layer containing the above-mentioned materials and a solvent; forming a coating film thereof on the photosensitive layer; and drying and/or curing the coating film. Examples of the solvent to be used for the coating liquid include an alcohol-based solvent, a ketone-based solvent, an ether-based solvent, a sulfoxide-based solvent, an ester-based solvent, and an aromatic hydrocarbon-based solvent.

The thickness of the protective layer is preferably 0.5 μm or more to 10 μm or less, more preferably 1 μm or more to 7 μm or less.

### <Surface Processing of Electrophotographic Photosensitive Member>

In the present disclosure, the surface processing of the electrophotographic photosensitive member may be performed. The performance of the surface processing can further stabilize the behavior of a cleaning unit (cleaning blade) to be brought into contact with the electrophotographic photosensitive member. A method for the surface processing is, for example, a method including bringing a mold having a convex portion into pressure contact with the surface of the electrophotographic photosensitive member to perform shape transfer, a method including imparting an uneven shape to the surface through mechanical polishing, or a method including causing powder to collide with the surface of the electrophotographic photosensitive member to roughen the surface. When a concave portion or a convex portion is arranged on the surface layer of the electrophotographic photosensitive member as described above, the behavior of the cleaning unit to be brought into contact with the electrophotographic photosensitive member can be further stabilized.

The above-mentioned concave portion or convex portion may be formed in the entire region of the surface of the electrophotographic photosensitive member, or may be formed on part of the surface of the electrophotographic photosensitive member. When the concave portion or the convex portion is formed on part of the surface of the electrophotographic photosensitive member, the concave portion or the convex portion is preferably formed in at least the entirety of the region of the photosensitive member to be brought into contact with the cleaning unit (cleaning blade).

When the concave portion is formed, the concave portion may be formed in the surface of the electrophotographic photosensitive member by bringing a mold having a convex portion corresponding to the concave portion into pressure contact with the surface of the electrophotographic photosensitive member to perform shape transfer.

### <Polishing Tool to be Used in Mechanical Polishing>

A known unit may be utilized in the mechanical polishing. In general, a polishing tool is brought into abutment with the electrophotographic photosensitive member, and one, or each of both, of the polishing tool and the electrophotographic photosensitive member is relatively moved to polish the surface of the electrophotographic photosensitive member. The polishing tool is a polishing member obtained by arranging, on a substrate, a layer obtained by dispersing polishing abrasive grains in a binder resin.

Examples of the abrasive grains include particles of aluminum oxide, chromium oxide, diamond, iron oxide, cerium oxide, corundum, silica, silicon nitride, boron nitride, molybdenum carbide, silicon carbide, tungsten carbide, titanium carbide, and silicon oxide. The particle diameter of each of the abrasive grains is preferably 0.01 μm or more and 50 μm or less, more preferably 1 μm or more and 15 μm or less. When the particle diameter of each of the abrasive grains is excessively small, their polishing power weakens to make it difficult to increase a F/C ratio, which is a molar fraction ratio between a fluorine atom F and a carbon atom C determined by X-ray photoelectron spectroscopy on the surface layer, on the outermost surface of the electrophotographic photosensitive member. Those abrasive grains may be used alone or as a mixture thereof. When two or more kinds of the abrasive grains are mixed, their materials or particle diameters may be different from or identical to each other.

A thermoplastic resin, a thermosetting resin, a reactive resin, an electron beam-curable resin, a UV-curable resin, a visible light-curable resin, and an antifungal resin that are known may each be used as the binder resin in which the abrasive grains to be used in the polishing tool are dispersed. Examples of the thermoplastic resin include a vinyl chloride resin, a polyamide resin, a polyester resin, a polycarbonate resin, an amino resin, a styrene-butadiene copolymer, a urethane elastomer, and a polyamide-silicone resin. Examples of the thermosetting resin include a phenol resin, a phenoxy resin, an epoxy resin, a polyurethane resin, a polyester resin, a silicone resin, a melamine resin, and an alkyd resin. In addition, an isocyanate-based curing agent may be added to the thermoplastic resin.

The thickness of the layer of the polishing tool, which is obtained by dispersing the abrasive grains in the binder resin, is preferably 1 μm or more to 100 μm or less. When the thickness is excessively large, thickness unevenness is liable to occur, and as a result, the unevenness of the surface roughness of a polishing target becomes a problem. Meanwhile, when the thickness is excessively small, the falling of the abrasive grains is liable to occur.

The shape of the substrate of the polishing tool is not particularly limited. Although a sheet-shaped substrate was used in each of Examples of the present disclosure for efficiently polishing a cylindrical electrophotographic photosensitive member, any other shape is permitted (the polishing tool of the present disclosure is hereinafter also described as “polishing sheet”). A material for the substrate of the polishing tool is also not particularly limited. A material for the sheet-shaped substrate is, for example, paper, a woven fabric, a nonwoven fabric, or a plastic film.

The polishing tool may be obtained by: mixing the abrasive grains and the binder resin as described above, and a solvent capable of dissolving the binder resin to disperse the materials in the solvent; applying the resultant paint onto the substrate; and drying the paint.

### <Polishing Apparatus>

An example of a polishing apparatus for the electrophotographic photosensitive member of the present disclosure is illustrated in FIG. 2.

FIG. 2 is an illustration of an apparatus for polishing a cylindrical electrophotographic photosensitive member with a polishing sheet. In FIG. 2, a polishing sheet 2-1 is wound around a hollow shaft 2-6, and a motor (not shown) is arranged so that a tension may be applied to the polishing sheet 2-1 in a direction opposite to the direction in which the polishing sheet 2-1 is fed to the shaft 2-6. The polishing sheet 2-1 is fed in a direction indicated by the arrow, and passes through a backup roller 2-3 via guide rollers 2-2a and 2-2b. The polishing sheet 2-1 after the polishing is taken up around a take-up unit 2-5 by the motor (not shown) via guide rollers 2-2c and 2-2d. The polishing is performed by bringing the polishing sheet 2-1 into pressure contact with a treatment target (electrophotographic photosensitive member before the performance of the polishing) 2-4 all the time. The polishing sheet 2-1 is often insulating, and hence a product connected to the ground or a product having electroconductivity is preferably used in a site with which the polishing sheet 2-1 is brought into contact.

The feeding speed of the polishing sheet 2-1 preferably falls within a range of 10 mm/min to 1,000 mm/min. When the feeding amount thereof is small, the binder resin adheres to the surface of the polishing sheet 2-1, and a deep flaw resulting from the adhesion occurs in the surface of the treatment target 2-4 in some cases.

The treatment target 2-4 is placed at a position facing the backup roller 2-3 through the polishing sheet 2-1. The backup roller 2-3 is preferably an elastic body from the viewpoint of improving the uniformity of the surface roughness of the treatment target 2-4. At this time, the treatment target 2-4 and the backup roller 2-3 are pressed against each other through the polishing sheet 2-1 at a pressure of a desired preset value for a predetermined time period. Thus, the surface of the treatment target 2-4 is polished. The rotation direction of the treatment target 2-4 may be identical to the direction in which the polishing sheet 2-1 is fed, or may be opposite thereto. In addition, the rotation direction may be changed in the middle of the polishing.

The pressure at which the backup roller 2-3 is pressed against the treatment target 2-4 is preferably 0.005 N/m2 to 15 N/m2, though the preferred value varies depending on the hardness of the backup roller 2-3 and a polishing time.

The surface roughness of the electrophotographic photosensitive member may be adjusted by appropriately selecting, for example, the feeding speed of the polishing sheet 2-1, the pressure at which the backup roller 2-3 is pressed against the treatment target, the kinds of the abrasive grains of the polishing sheet, the thickness of the binder resin of the polishing sheet, and the thickness of the substrate.

### <Measurement of Maximum Height Rmax in JIS B 0601 1982>

The surface roughness of the electrophotographic photosensitive member may be measured with a known unit. Examples thereof include the following: a surface roughness meter such as a surface roughness measuring instrument SURFCORDER SE3500 manufactured by Kosaka Laboratory Ltd.; a non-contact three-dimensional surface-measuring machine MICROMAP 557N manufactured by Ryoka Systems Inc.; and a microscope capable of obtaining a three-dimensional shape, such as an ultra-depth shape-measuring microscope VK-8550 or VK-9000 manufactured by Keyence Corporation.

In the present disclosure, out of the indices of a surface roughness, a maximum height Rmax in JIS B 0601 1982 specified by Japanese Industrial Standards (JIS) is used as a polishing depth L (μm). In addition, in the present disclosure, the Rmax is measured in advance for a 5-millimeter square section range of the electrophotographic photosensitive member to be cut out as a specimen for X-ray photoelectron spectroscopy to be described later. The measurement is performed at 3 arbitrary sites in the 5-millimeter square range of the electrophotographic photosensitive member cut out, and the average of the measured values is adopted as the polishing depth L (μm).

### <Electrophotographic Intermediate Transfer Belt>

The surface layer of the intermediate transfer belt of the present disclosure contains the perfluoropolyether, the binding material, and the polymer B including the structural unit represented by the formula (2).

### <Base Layer>

An intermediate transfer belt 30 includes the following two layers: a base layer 31; and a surface layer 32 arranged on the outer periphery of the base layer 31, as illustrated in FIG. 6.

A material for forming the base layer 31 is preferably a resin having mechanical strength and bending resistance as an intermediate transfer belt for an image forming apparatus.

Specific examples of such resin include the following: polyamide, polyacetal, polyarylate, polycarbonate, polyphenylene ether, polyethylene terephthalate, polyethylene naphthalate, polybutylene naphthalate, polysulfone, polyethersulfone, polyphenyl sulfide, polybutylene terephthalate, polyetheretherketone, polyvinylidene fluoride, polyvinyl fluoride, a polyether amide copolymer, a polyurethane copolymer, polyimide, and polyamide imide.

The base layer 31 is preferably formed from one kind of those resins or a mixture thereof.

In general, an electroconductive substance may be added to the base layer 31 in order to impart electroconductivity. Examples of the electroconductive substance include inorganic electroconductive particles including: carbon-based inorganic electroconductive particles, such as carbon black, carbon fibers, and carbon nanotubes; and metal oxides, such as zinc antimonate, zinc oxide, tin oxide, and titanium oxide.

It is preferred that the volume resistivity of the base layer 31 be adjusted to a range of 1×10⁸ [Ω·cm] or more to 1×10¹² [(Ω·cm] or less. When the volume resistivity of the base layer 31 is set to 1×10¹² [Ω·cm] or less, decreases in primary transferability and secondary transferability caused by the application of a predetermined transfer bias can be more reliably suppressed. In addition, when the volume resistivity of the base layer 31 is set to 1×10⁸ [Ω·cm] or more, the occurrence of resistance unevenness can be suppressed, and the occurrence of transfer unevenness and the like and the occurrence of an image defect can be more reliably prevented.

In addition, it is preferred that the surface resistivity of the base layer 31 be adjusted to a range of 1×10⁸ [Ω/□] or more to 1×10¹⁴ [(Ω/□] or less.

When the surface resistivity of the base layer 31 is set to the above-mentioned range, an image defect caused by peeling discharge and toner scattering at the time of the separation of a transfer material from the intermediate transfer belt can be more reliably reduced. The thickness of the base layer 31 is preferably 40 μm or more to 200 μm or less from the viewpoints of mechanical strength and bending resistance.

### <Surface Layer>

The surface layer 32 contains the binder resin serving as the binding material, the perfluoropolyether (hereinafter also referred to as “PFPE”), and the polymer B including the structural unit represented by the formula (2).

The polymer B is a copolymer of an acrylate having a fluoroalkyl group and a methacrylate macromonomer having polymethyl methacrylate in its side chain, and has a number-average molecular weight of 11,000 or more to 15,000 or less and a peak top molecular weight of 24,000 or more to 40,000 or less.

The surface layer 32 may contain a photopolymerization initiator, an electroconductive substance, and the like in addition to the binder resin, the PFPE, and the dispersant.

### <Binder Resin>

A styrene resin, an acrylic resin, a methacrylic resin, an epoxy resin, a polyester resin, a polyether resin, a silicone resin, and a polyvinyl butyral resin, and mixed resins thereof may each be used as the binder resin serving as the binding material.

The binder resin is used for dispersing the PFPE, ensuring adhesiveness with the base layer 31, and ensuring a mechanical strength characteristic.

Of the above-mentioned binder resins, a methacrylic resin or an acrylic resin is preferably used because the resin enables the PFPE for forming the surface layer 32 of the intermediate transfer belt to be satisfactorily dispersed. The methacrylic resin and the acrylic resin are hereinafter collectively referred to as “(meth)acrylic resin”.

A polymerizable monomer for forming the (meth)acrylic resin is, for example, the following (i) or (ii). A polymerizable monomer commercially available as paint may also be used as the polymerizable monomer.

(i) At least one kind of acrylate selected from the group consisting of: pentaerythritol triacrylate; pentaerythritol tetraacrylate; ditrimethylolpropane tetraacrylate; dipentaerythritol hexaacrylate; an alkyl acrylate; benzyl acrylate; phenyl acrylate; ethylene glycol diacrylate; and bisphenol A diacrylate.

(ii) At least one kind of methacrylate selected from the group consisting of: pentaerythritol trimethacrylate; pentaerythritol tetramethacrylate; ditrimethylolpropane tetramethacrylate; dipentaerythritol hexamethacrylate; an alkyl methacrylate; benzyl methacrylate; phenyl methacrylate; ethylene glycol dimethacrylate; and bisphenol A dimethacrylate.

Of those, a polymerizable monomer having high hardness is preferred in consideration of rubbing against other members, such as a photosensitive member and a cleaning blade. For this reason, it is preferred to use a bifunctional or higher crosslinkable monomer for the (meth)acrylic resin to provide higher hardness.

In addition, in order to form the acrylic resin from such polymerizable monomer, a method including adding a photopolymerization initiator and polymerizing the monomer with an electron beam or UV light is available.

Examples of the photopolymerization initiator include radical-generating photopolymerization initiators, such as benzophenone, thioxanthone, benzyl dimethyl ketal, a-hydroxyketone, a-hydroxyalkylphenone, a-aminoketone, a-aminoalkylphenone, monoacylphosphine oxide, bisacylphosphine oxide, hydroxybenzophenone, aminobenzophenone, titanocene, oxime ester, and oxyphenylacetic acid ester-based photopolymerization initiators.

The content of the binder resin in the surface layer is preferably set to 20 mass % or more to 70 mass % or less with respect to the mass of the total solid content of the surface layer 32 in order to impart excellent strength to the surface layer and to impart excellent toner releasability to the outer surface of the surface layer.

### <Perfluoropolyether (PFPE)>

The PFPE refers to an oligomer or a polymer having a perfluoroalkylene ether as a repeating unit.

Examples of the perfluoroalkylene ether repeating unit include perfluoromethylene ether, perfluoroethylene ether, and perfluoropropylene ether repeating units. Commercially available products, such as “DEMNUM” (product name; manufactured by Daikin Industries, Ltd.), “Krytox” (product name; manufactured by DuPont), and “Fomblin” (product name, manufactured by Solvay Specialty Polymers), may each be used as the PFPE.

A weight-average molecular weight Mw of the PFPE is preferably 1,000 or more to 9,000 or less from the viewpoint of the migration property of the PFPE to the surface of the intermediate transfer belt.

The weight-average molecular weight as used herein refers to a value obtained by dissolving a PFPE in “ZEORORA H” (product name; manufactured by Zeon Corporation) and measuring the solution with a liquid chromatography analysis apparatus (manufactured by Shimadzu Corporation).

The compound name of “ZEORORA H” is 1,1,2,2,3,3,4-heptafluorocyclopentane.

In addition, the PFPE may have a reactive functional group that can form a bond or a state close to a bond with the binder resin, or a non-reactive functional group that cannot form a bond or a state close to a bond with the binder resin.

When the PFPE has the above-mentioned reactive functional group, its interaction with the binder resin results in satisfactory compatibility between the binder resin and the PFPE and stable dispersion. For example, when the binder resin is formed by an addition reaction, a reactive functional group that causes an addition reaction with a monomer for forming the binder resin is, for example, an acrylic group, a methacrylic group, or an oxysilanyl group.

Examples of commercially available products of the PFPE having such reactive functional group include: “Fluorolink MD500”, “Fluorolink MD700”, “Fluorolink 5101X”, “Fluorolink 5113X”, and “Fluorolink AD1700” (product names; manufactured by Solvay Specialty Polymers); and “OPTOOL DAC” (product name; manufactured by Daikin Industries, Ltd.).

“Fluorolink MD500” is a PFPE having a methacrylic group as a functional group, and “Fluorolink AD1700” is a PFPE having an acrylic group as a functional group.

In addition, when the binder resin is formed by an addition reaction, a non-reactive functional group that does not cause an addition reaction with a monomer for forming the binder resin is, for example, a hydroxyl group, a trifluoromethyl group, or a methyl group. Examples of commercially available products of the PFPE having such non-reactive functional group include: “Fluorolink D10H”, “Fluorolink D4000”, and “Fomblin Z15” (product names; manufactured by Solvay Specialty Polymers); and “DEMNUM S-20”, “DEMNUM S-65”, and “DEMNUM S-200” (product names, manufactured by Daikin Industries, Ltd.).

Of those, the PFPE having the non-reactive functional group is preferred from the viewpoint of achieving easier migration of the PFPE to the surface of the intermediate transfer belt and higher releasability of the surface of the intermediate transfer belt.

In addition, the content of the PFPE in the surface layer is preferably 20 mass % or more to 40 mass % or less with respect to the mass of the total solid content of the surface layer.

When the content of the PFPE is adjusted to the above-mentioned range, the PFPE can be supplied from the inside of the surface layer of the intermediate transfer belt to the surface of the intermediate transfer belt to suppress a decrease in releasability of the surface of the intermediate transfer belt even when transfer is repeatedly performed.

### <Electroconductive Agent>

It is preferred that the intermediate transfer belt after the formation of the surface layer 32 on the base layer 31 also exhibit the same level of value in electric resistance. Thus, it is preferred that the surface layer 32 be also semi-electroconductive. That is, it is preferred that the volume resistivity of the intermediate transfer belt be adjusted to a range of 1×10⁸ [Ω·cm] or more to 1×10¹² [Ω·cm] or less. In addition, it is preferred that the surface resistivity of the intermediate transfer belt be adjusted to a range of 1×10⁸ [Ω/□] or more to 1×10¹⁴ [Ω/□] or less. In order to adjust the volume resistivity and surface resistivity of the intermediate transfer belt, it is preferred that the surface layer 32 contain an electroconductive agent.

The electroconductive agent may be added to the surface layer 32 in order to impart electroconductivity. Examples of the electroconductive agent include: carbon-based inorganic electroconductive particles, such as carbon black, carbon fibers, and carbon nanotubes; and metal oxides, such as zinc antimonate, zinc oxide, tin oxide, and titanium oxide.

The surface layer 32 contain the binding material and the PFPE, and it is preferred that the surface layer have a matrix-domain structure in a thickness direction thereof, and the domains have an average long diameter of 1 nm or more to 60 nm or less.

### <Matrix-Domain Structure>

The surface layer 32 has a matrix-domain structure in a thickness direction thereof. The surface free energy of the PFPE is significantly small. Thus, when the PFPE is incorporated into the surface layer 32 of the intermediate transfer belt, the adhesion property of toner to the surface of the surface layer 32 can be reduced. Incidentally, the PFPE easily migrates to the interface between the surface layer 32 and air, that is, the outermost surface side of the surface layer 32 because of the characteristic of significantly small surface free energy. That is, the PFPE is easily distributed unevenly to the surface side of the surface layer 32.

In this aspect, the PFPE having such characteristic is randomly distributed in the thickness direction of the surface layer 32 by causing the PFPE to be present as domains in a matrix resin forming the surface layer 32.

The foregoing indicates that the PFPE is present throughout the entire surface layer as well as on the outermost surface of the surface layer 32, and also indicates that a large amount of the PFPE forming the domains is present. As a result, even when the surface layer 32 of the intermediate transfer belt undergoes various chemical and physical deteriorations through repeated image output and the PFPE on the surface disappears, the domains of the PFPE that are present inside the surface layer 32 are exposed on the surface of the surface layer 32. This configuration allows the PFPE to be always present on the surface of the surface layer 32. Thus, it is conceived that the intermediate transfer belt according to the present disclosure can maintain a satisfactory transfer characteristic.

The foregoing is also supported by the experimental results that, in the intermediate transfer belt according to this aspect, a PFPE-derived peak is detected at a value to the same degree as that in an initial state as a result of surface analysis by X-ray photoelectron spectroscopy (XPS) even after the intermediate transfer belt has been subjected to image output on a large number of sheets.

In addition, as described above, the surface layer 32 of the intermediate transfer belt according to this aspect has a matrix-domain structure in the thickness direction thereof. Thus, the domains each containing the PFPE are randomly distributed in the thickness direction of the surface layer 32, that is, from the base layer 31 side to the outermost surface side of the surface layer 32.

In the surface layer having such configuration, the domains located on the outermost surface side of the surface layer 32 are partially exposed on the surface or are exposed in the most initial stage of image formation. As a result, a state in which a matrix is dotted with domains each containing the PFPE is also formed on the surface of the surface layer 32. As described above, toner is less liable to stick to the surface including regions that have different adhesion properties with respect to toner, and this form is preferred for allowing a satisfactory transfer characteristic to be maintained.

Further, depending on the kinds and combinations of the components to be used in forming the surface layer 32, such as the binding material, the PFPE, the solvent, and the dispersant to be incorporated into the matrix, the structure may have voids in some of the PFPE domains exposed on the outermost surface of the surface layer 32.

In a form in which the outermost surface is dotted with concave shapes in the form of an island due to the presence of such voids, the outermost surface is easily scraped by the physical action of sliding of a cleaning blade, paper, and the like. As a result, the PFPE domains present in the thickness direction easily appear on the outermost surface because of the acceleration of the supply of the PFPE from the PFPE domains each having a concave shape and the easier scraping of the outmost surface, and thus the action of the PFPE is effectively exhibited. In addition, the concave shapes reduce the contact area between the outermost surface and the toner, and hence the adhesive force of the toner to the surface layer 32 is reduced. It can be said that, mainly with those three actions, the structure in which voids are present in some of the PFPE domains exposed on the outermost surface of the surface layer is a preferred form as a structure that maintains a satisfactory transfer characteristic. The effect of the shape described here can be exhibited also by controlling the shape of the outermost surface through physical surface processing, such as nanoimprinting or lapping.

In the matrix-domain structure, the average long diameter of the domains is 1 nm or more to 60 nm or less. When the average long diameter of the domains is set to 1 nm or more, a matrix-domain structure is formed, the adhesion property with respect to toner is reduced for a long period of time, and a satisfactory transfer characteristic can be maintained. In addition, when the average long diameter of the domains is set to 60 nm or less, surface glossiness can be maintained for a long period of time.

The average long diameter of the domains may be measured by a method described in Examples.

In addition, even when polytetrafluoroethylene particles that are also a fluorine compound are simply dispersed in the surface layer 32 of the intermediate transfer belt, it is difficult to obtain the effect exhibited by the intermediate transfer belt according to this aspect. The foregoing is also the reason why the effect is conceived to be exhibited by the action of the PFPE.

Further, although it is preferred that the domains be substantially formed of only the PFPE, chemical species except the PFPE may be present in the domains in addition to the PFPE to the extent that the effect exhibited by the intermediate transfer belt according to this aspect is exhibited. An additive that is compatible with the PFPE may also be added for the purpose of adjusting other characteristics. Further, the same effect can be exhibited even when the domains are not completely filled with the PFPE and voids are present.

The domains each containing the PFPE are phase-separated from the matrix containing the binding material. However, in general, even when the domains are phase-separated, the composition of the matrix and domain components is not exact. Even in a matrix and a domain that are phase-separated from each other to have a well-defined interface therebetween, each phase may contain a trace amount of a component of a different phase. In addition, it is also said academically that intermediate composition is present at the interface with a significantly narrow width of about 10 nm. In the present disclosure, the presence or absence of the matrix-domain structure may be recognized by cutting out the intermediate transfer belt and observing the cross-section of the surface layer 32 of the intermediate transfer belt in the thickness direction with a scanning electron microscope (SEM).

Meanwhile, in the surface layer 32 in which a matrix-domain structure is observed in a cross-section in the thickness direction, a state in which the outermost surface is dotted with regions each containing the PFPE in the form of an island is easily formed as described above. Thus, when the outermost surface of the surface layer 32 is observed with the SEM, a state in which the outermost surface is dotted with regions each containing the PFPE in the form of an island is often observed.

The fact that the domain contains the PFPE may be identified through detection by an elemental analysis method, such as energy dispersive X-ray analysis (EDX), time-of-flight secondary ion mass spectrometry (TOF-SIMS), or Auger spectroscopy. For example, when the domain was elementally analyzed by EDX in the intermediate transfer belt, a fluorine element was detected, and the domain was identified as the domain containing the PFPE. In addition, a fragment of a fluorocarbon ether structure derived from PFPE was also able to be observed from the domain by TOF-SIMS.

### <Process Cartridge and Electrophotographic Apparatus>

The electrophotographic photosensitive member of the present disclosure may be one constituent for a process cartridge or an electrophotographic apparatus. The process cartridge is characterized by integrally supporting the electrophotographic photosensitive member described in the foregoing, and at least one unit selected from the group consisting of: a charging unit; a developing unit; a transferring unit; and a cleaning unit, and being detachably attachable to the main body of an electrophotographic apparatus. In addition, the electrophotographic apparatus is characterized by including: the electrophotographic photosensitive member described in the foregoing; a charging unit; an exposing unit; a developing unit; and a transferring unit.

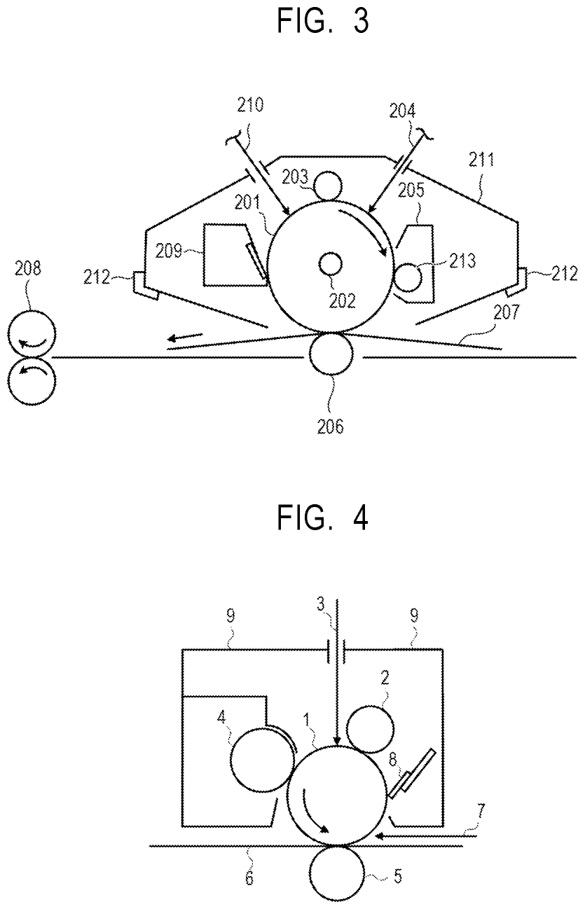

An example of the schematic configuration of an electrophotographic apparatus including a process cartridge including the electrophotographic photosensitive member of the present disclosure is illustrated in FIG. 3.

An electrophotographic photosensitive member 201 of a cylindrical shape (drum shape) is rotationally driven about a shaft 202 in a direction indicated by the arrow at a predetermined peripheral speed (process speed). The surface of the electrophotographic photosensitive member 201 is charged to a predetermined positive or negative potential by a charging unit 203 in the rotational process. In FIG. 3, a roller charging system based on a roller type charging member is illustrated, but a charging system, such as a corona charging system, a proximity charging system, or an injection charging system, may be adopted. The charged surface of the electrophotographic photosensitive member 201 is irradiated with exposure light 204 from an exposing unit (not shown), and hence an electrostatic latent image corresponding to target image information is formed thereon. The exposure light 204 is light whose intensity has been modulated in correspondence with a time-series electric digital image signal of information on a target image, and is emitted, for example, from an image exposing unit, such as slit exposure or laser beam scanning exposure. The electrostatic latent image formed on the surface of the electrophotographic photosensitive member 201 is developed (normal development or reversal development) with toner on a developing member 213 stored in a developing unit 205 to form a toner image on the surface of the electrophotographic photosensitive member 201. The toner image formed on the surface of the electrophotographic photosensitive member 201 is transferred by a transferring unit 206 onto a transfer material 207. At this time, a bias voltage opposite in polarity to charge that the toner possesses is applied from a bias power source (not shown) to the transferring unit 206. In addition, when the transfer material 207 is paper, the transfer material 207 is taken out of a sheet feeding portion (not shown) and supplied to a space between the electrophotographic photosensitive member 201 and the transferring unit 206 in sync with the rotation of the electrophotographic photosensitive member 201. The transfer material 207 onto which the toner image has been transferred from the electrophotographic photosensitive member 201 is separated from the surface of the electrophotographic photosensitive member 201, is conveyed to a fixing unit 208, and is subjected to treatment for fixing the toner image to be printed out as an image-formed product (a print or a copy) to the outside of the electrophotographic apparatus. The electrophotographic apparatus may include a cleaning unit 209 for removing a deposit such as the toner remaining on the surface of the electrophotographic photosensitive member 201 after the transfer. In addition, a so-called cleaner-less system configured to remove the deposit with the developing unit or the like without separate arrangement of a cleaning unit may be used. A plurality of constituents selected from the electrophotographic photosensitive member 201, the charging unit 203, the developing unit 205, the cleaning unit 209, and the like may be stored in a container and integrally supported to form a process cartridge. In addition, the process cartridge may be detachably attachable to the main body of the electrophotographic apparatus. For example, such a configuration as described below may be adopted. At least one selected from the charging unit 203, the developing unit 205, and the cleaning unit 209 is integrally supported with the electrophotographic photosensitive member 201 to form a cartridge. The cartridge may be used as a process cartridge 211 detachably attachable to the main body of the electrophotographic apparatus with a guiding unit 212 such as a rail of the main body of the electrophotographic apparatus. The electrophotographic apparatus may include an electricity-removing mechanism configured to subject the surface of the electrophotographic photosensitive member 201 to electricity-removing treatment with pre-exposure light 210 from a pre-exposing unit (not shown). In addition, the guiding unit 212 such as the rail may be arranged for detachably attaching the process cartridge 211 to the main body of the electrophotographic apparatus. The electrophotographic apparatus of the present disclosure is characterized by including the electrophotographic photosensitive member 201, the charging unit 203, the exposing unit, the developing unit 205, and the transferring unit 206.

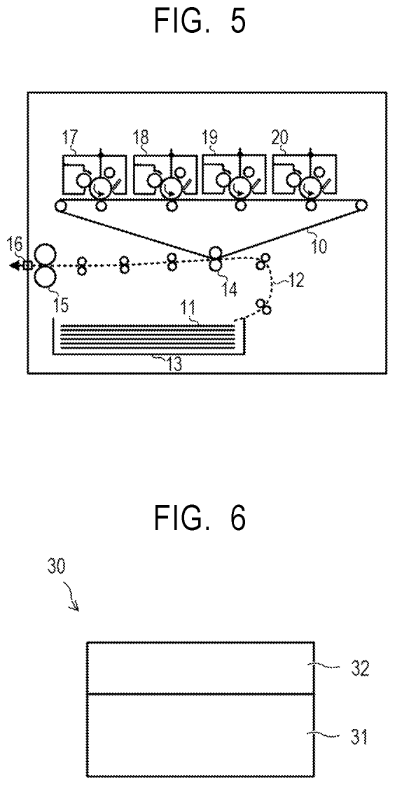

In addition, an example of the schematic configuration of a process cartridge including the electrophotographic photosensitive member of the present disclosure is illustrated in FIG. 4, and an example of the schematic configuration of an electrophotographic apparatus including the process cartridge of FIG. 4 is illustrated in FIG. 5.

In FIG. 4, an electrophotographic photosensitive member 1 of a cylindrical shape is rotationally driven in a direction indicated by the arrow at a predetermined peripheral speed. The peripheral surface of the electrophotographic photosensitive member 1 to be rotationally driven is uniformly charged to a positive or negative predetermined potential by a charging unit 2. Next, the charged peripheral surface of the electrophotographic photosensitive member 1 receives exposure light (image exposure light) 3 emitted from an exposing unit (not shown), such as slit exposure or laser beam scanning exposure. Thus, electrostatic latent images corresponding to a target image are sequentially formed on the peripheral surface of the electrophotographic photosensitive member 1. Any one of a voltage obtained by superimposing an AC component on a DC component and a voltage formed only of a DC component may be used as a voltage to be applied to the charging unit (e.g., a charging roller) 2.

The electrostatic latent images formed on the peripheral surface of the electrophotographic photosensitive member 1 are developed with toner in the developer of a developing unit 4 to turn into toner images. Next, the toner images formed and carried on the peripheral surface of the electrophotographic photosensitive member 1 are sequentially transferred onto a transfer material (e.g., paper or an intermediate transfer member) 6 by a transfer bias from a transfer unit (e.g., a transfer roller) 5. The transfer material 6 is fed in sync with the rotation of the electrophotographic photosensitive member 1.

The surface of the electrophotographic photosensitive member 1 after the transfer of the toner images is subjected to electricity-removing treatment by pre-exposure light 7 from a pre-exposing unit (not shown). After that, transfer residual toner is removed from the surface by a cleaning unit 8, and hence the surface is cleaned. Thus, the electrophotographic photosensitive member 1 is repeatedly used in image formation. The electricity-removing treatment by the pre-exposing unit may be performed before the cleaning process or may be performed thereafter, and the pre-exposing unit is not necessarily required.

The electrophotographic photosensitive member 1 may be mounted on an electrophotographic apparatus, such as a copying machine or a laser beam printer. In addition, a process cartridge 9, which is formed by storing a plurality of constituents out of the constituents, such as the electrophotographic photosensitive member 1, the charging unit 2, the developing unit 4, and the cleaning unit 8, in a container, and integrally supporting the stored constituents, may be detachably attachable to the main body of the electrophotographic apparatus. In FIG. 4, the electrophotographic photosensitive member 1, the charging unit 2, the developing unit 4, and the cleaning unit 8 are integrally supported to form the process cartridge 9 detachably attachable to the main body of the electrophotographic apparatus.

Next, the electrophotographic apparatus including the electrophotographic photosensitive member of the present disclosure is described.

An example of the configuration of the electrophotographic apparatus of the present disclosure is illustrated in FIG. 5. A process cartridge 17 for a yellow color, a process cartridge 18 for a magenta color, a process cartridge 19 for a cyan color, and a process cartridge 20 for a black color corresponding to a yellow color, a magenta color, a cyan color, and a black color, respectively, are arranged side by side along an intermediate transfer member 10. It is not necessarily required to unify the diameters and constituent materials of the electrophotographic photosensitive members, developers, charging systems, and the other units among the respective colors.

Once an image-forming operation starts, the toner images of the respective colors are sequentially superimposed on the intermediate transfer member 10 in accordance with the above-mentioned image-forming process. In parallel with the foregoing, a transfer sheet 11 is fed from a sheet-feeding tray 13 by a sheet-feeding path 12, and is fed to a secondary transfer unit 14 at the same timing as that of the rotation operation of the intermediate transfer member. The toner images on the intermediate transfer member 10 are transferred onto the transfer sheet 11 by a transfer bias from the secondary transfer unit 14. The toner images transferred onto the transfer sheet 11 are conveyed along the sheet-feeding path 12, and are fixed onto the transfer sheet by a fixing unit 15, followed by the delivery of the sheet from a sheet delivery portion 16.

The electrophotographic photosensitive member of the present disclosure may be used in, for example, a laser beam printer, an LED printer, a copying machine, a facsimile, and a multifunctional peripheral thereof.

### EXAMPLES

The present disclosure is described in more detail below by way of Examples and Comparative Examples, but is not limited thereto. In the description of Examples below, the term “part(s)” means “part(s) by mass” unless otherwise stated.

<Synthesis of Polymer a Including Structural Unit Represented by Formula (1) and Polymer B including Structural Unit represented by Formula (2)>

The polymer A including the structural unit represented by the formula (1) (hereinafter also represented as “graft copolymer A”) and the polymer B including the structural unit represented by the formula (2) (hereinafter also represented as “graft copolymer B”) in the present disclosure were synthesized as described below.

Acrylate compounds and a macromonomer compound used in the following synthesis examples may be produced with reference to, for example, Japanese Patent Application Laid-Open No. 2009-104145.

### (Graft Copolymer A-1)

3.31 Parts of 1H,1H,2H,2H-perfluorohexyl methacrylate (manufactured by FUJIFILM Wako Pure Chemical Corporation), 180 parts of a macromonomer represented by the following formula (M-1) (number-average molecular weight: 6,000), 14.18 parts of 1,1′-azobis(1-acetoxy-1-phenylethane) (product name: OTAZO-15, manufactured by Otsuka Chemical Co., Ltd.), and 900 parts of n-butyl acetate were mixed in a glass-made flask including a stirring machine, a reflux condenser, a nitrogen gas-introducing tube, a thermostat, and a temperature gauge at 20° C. under a nitrogen atmosphere for 30 minutes. After that, the mixture was subjected to a reaction for 5 hours while being warmed so that the temperature of a reaction liquid became 85° C. to 90° C. The reaction was stopped by ice cooling, and 4,500 parts of 2-propanol was added to the reaction liquid to provide a precipitate. The precipitate was washed with a mixed solvent containing n-butyl acetate and 2-propanol at 1:5, and was dried at a temperature of 80° C. under a decompressed state of 1,325 Pa or less for 3 hours to provide a graft copolymer A-1.

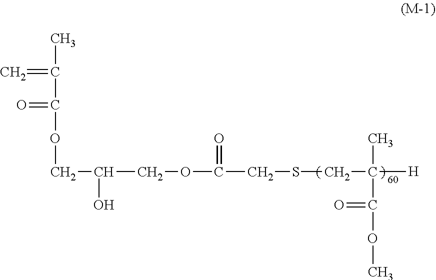 [SMILES: C=C(C)C(=O)OCC(O)COC(=O)CSCC(C)C(=O)OC]

### (Graft Copolymer A-2)

A graft copolymer A-2 was obtained in the same manner as in the synthesis example of the graft copolymer A-1 except that 1H, 1H,2H,2H-perfluorohexyl methacrylate was changed to 2.81 parts of 1H, 1H,2H,2H-perfluoropentyl methacylate.

### (Graft Copolymer A-3)

A graft copolymer A-3 was obtained in the same manner as in the synthesis example of the graft copolymer A-1 except that 1H, 1H,2H,2H-perfluorohexyl methacrylate was changed to 3.81 parts of 1H, 1H,2H,2H-perfluoroheptyl methacylate.

### (Graft Copolymer A-4)

A graft copolymer A-4 was obtained in the same manner as in the synthesis example of the graft copolymer A-1 except that the usage amount of 1,1′-azobis(1-acetoxy-1-phenylethane) was changed to 70.88 parts.

### (Graft Copolymer A-5)

A graft copolymer A-5 was obtained in the same manner as in the synthesis example of the graft copolymer A-1 except that the usage amount of 1,1′-azobis(1-acetoxy-1-phenylethane) was changed to 42.53 parts.

### (Graft Copolymer A-6)

A graft copolymer A-6 was obtained in the same manner as in the synthesis example of the graft copolymer A-1 except that the usage amount of 1,1′-azobis(1-acetoxy-1-phenylethane) was changed to 17.72 parts.

### (Graft Copolymer A-7)

A graft copolymer A-7 was obtained in the same manner as in the synthesis example of the graft copolymer A-1 except that the usage amount of 1,1′-azobis(1-acetoxy-1-phenylethane) was changed to 11.70 parts.

### (Graft Copolymer A-8)

A graft copolymer A-8 was obtained in the same manner as in the synthesis example of the graft copolymer A-1 except that the usage amount of 1,1′-azobis(1-acetoxy-1-phenylethane) was changed to 8.51 parts.

### (Graft Copolymer A-9)

A graft copolymer A-9 was obtained in the same manner as in the synthesis example of the graft copolymer A-1 except that the usage amount of 1,1′-azobis(1-acetoxy-1-phenylethane) was changed to 7.80 parts.

### (Graft Copolymer A-10)

A graft copolymer A-10 was obtained in the same manner as in the synthesis example of the graft copolymer A-1 except that the usage amount of 1,1′-azobis(1-acetoxy-1-phenylethane) was changed to 6.38 parts.

### (Graft Copolymer A-11)

A graft copolymer A-11 was obtained in the same manner as in the synthesis example of the graft copolymer A-1 except that the usage amount of the macromonomer represented by the formula (M-1) was changed to 1,440 parts, the usage amount of 1,1′-azobis(1-acetoxy-1-phenylethane) was changed to 88.60 parts, and the usage amount of n-butyl acetate was changed to 4,500 parts.

### (Graft Copolymer A-12)

A graft copolymer A-12 was obtained in the same manner as in the synthesis example of the graft copolymer A-1 except that the usage amount of the macromonomer represented by the formula (M-1) was changed to 1,140 parts, the usage amount of 1,1′-azobis(1-acetoxy-1-phenylethane) was changed to 70.88 parts, and the usage amount of n-butyl acetate was changed to 4,200 parts.

### (Graft Copolymer A-13)

A graft copolymer A-13 was obtained in the same manner as in the synthesis example of the graft copolymer A-1 except that the usage amount of the macromonomer represented by the formula (M-1) was changed to 240 parts, the usage amount of 1,1′-azobis(1-acetoxy-1-phenylethane) was changed to 17.72 parts, and the usage amount of n-butyl acetate was changed to 1,200 parts.

### (Graft Copolymer A-14)

A graft copolymer A-14 was obtained in the same manner as in the synthesis example of the graft copolymer A-1 except that the usage amount of 1H, 1H,2H,2H-perfluorohexyl methacrylate was changed to 2.98 parts, the usage amount of the macromonomer represented by the formula (M-1) was changed to 66 parts, the usage amount of 1,1′-azobis(1-acetoxy-1-phenylethane) was changed to 7.09 parts, and the usage amount of n-butyl acetate was changed to 500 parts.

### (Graft Copolymer A-15)

A graft copolymer A-15 was obtained in the same manner as in the synthesis example of the graft copolymer A-1 except that the usage amount of the macromonomer represented by the formula (M-1) was changed to 60 parts, the usage amount of 1,1′-azobis(1-acetoxy-1-phenylethane) was changed to 7.09 parts, and the usage amount of n-butyl acetate was changed to 500 parts.

### (Graft Copolymer A-16)

A graft copolymer A-16 was obtained in the same manner as in the synthesis example of the graft copolymer A-1 except that the usage amount of 1H,1H,2H,2H-perfluorohexyl methacrylate was changed to 3.64 parts, the usage amount of the macromonomer represented by the formula (M-1) was changed to 54 parts, the usage amount of 1,1′-azobis(1-acetoxy-1-phenylethane) was changed to 7.09 parts, and the usage amount of n-butyl acetate was changed to 500 parts.

### (Graft Copolymer B-1)

A graft copolymer B-1 was obtained by performing preparation with a preparative HPLC apparatus for a compound obtained in the same manner as in the synthesis example of the graft copolymer A-1 except that 1H, 1H,2H,2H-perfluorohexyl methacrylate was changed to 3.17 parts of 1H, 1H,2H,2H-perfluorohexyl acrylate.

### (Graft Copolymer B-2)

A graft copolymer B-2 was obtained by performing preparation using a preparative HPLC apparatus for a compound obtained in the same manner as in the synthesis example of the graft copolymer A-1 except that 1H, 1H,2H,2H-perfluorohexyl methacrylate was changed to 2.81 parts of 1H, 1H,2H,2H-perfluoropentyl acrylate.

### (Graft Copolymer B-3)

A graft copolymer B-3 was obtained by performing preparation with a preparative HPLC apparatus for a compound obtained in the same manner as in the synthesis example of the graft copolymer A-1 except that 1H, 1H,2H,2H-perfluorohexyl methacrylate was changed to 3.81 parts of 1H,1H,2H,2H-perfluoroheptyl acrylate.

### (Graft Copolymer B-4)

A graft copolymer B-4 was obtained by performing preparation with a preparative HPLC apparatus at an elution time different from that of the graft copolymer B-1 for the compound obtained in the same manner as in the synthesis example of the graft copolymer A-1 except that 1H, 1H,2H,2H-perfluorohexyl methacrylate was changed to 3.17 parts of 1H, 1H,2H,2H-perfluorohexyl acrylate.

### (Graft Copolymer B-5)

A graft copolymer B-5 was obtained by performing preparation with a preparative HPLC apparatus at an elution time different from that of the graft copolymer B-1 for the compound obtained in the same manner as in the synthesis example of the graft copolymer A-1 except that 1H, 1H,2H,2H-perfluorohexyl methacrylate was changed to 3.17 parts of 1H, 1H,2H,2H-perfluorohexyl acrylate.

### (Graft Copolymer B-6)

A graft copolymer B-6 was obtained by performing preparation with a preparative HPLC apparatus at an elution time different from that of the graft copolymer B-1 for the compound obtained in the same manner as in the synthesis example of the graft copolymer A-1 except that 1H, 1H,2H,2H-perfluorohexyl methacrylate was changed to 3.17 parts of 1H, 1H,2H,2H-perfluorohexyl acrylate.

### (Graft Copolymer B-7)

A graft copolymer B-7 was obtained by performing preparation with a preparative HPLC apparatus at an elution time different from that of the graft copolymer B-1 for the compound obtained in the same manner as in the synthesis example of the graft copolymer A-1 except that 1H, 1H,2H,2H-perfluorohexyl methacrylate was changed to 3.17 parts of 1H, 1H,2H,2H-perfluorohexyl acrylate.

### (Graft Copolymer B-8)

A graft copolymer B-8 was obtained by performing preparation with a preparative HPLC apparatus at an elution time different from that of the graft copolymer B-1 for the compound obtained in the same manner as in the synthesis example of the graft copolymer A-1 except that 1H, 1H,2H,2H-perfluorohexyl methacrylate was changed to 3.17 parts of 1H, 1H,2H,2H-perfluorohexyl acrylate.

### (Graft Copolymer B-9)

A graft copolymer B-9 was obtained by performing preparation with a preparative HPLC apparatus at an elution time different from that of the graft copolymer B-1 for the compound obtained in the same manner as in the synthesis example of the graft copolymer A-1 except that 1H, 1H,2H,2H-perfluorohexyl methacrylate was changed to 3.17 parts of 1H, 1H,2H,2H-perfluorohexyl acrylate.

The resultant graft copolymers A-1 to A-16 were each subjected to GPC measurement by the above-mentioned method to calculate a weight-average molecular weight. The results are shown in Table 4.

TABLE 4

| | | | GPC measurement |
|---|---|---|---|
| Number of | | | result |
| graft | Unit structure represented by formula (1) | | Weight-average |
| copolymer | R¹¹ | Rf¹ | molecular weight |
| A-1 | —CH₂—CH₂— | —CF₂—CF₂—CF₂—CF₃ | 151,000 |
| A-2 | —CH₂—CH₂— | —CF₂—CF₂—CF₃ | 152,000 |
| A-3 | —CH₂—CH₂— | —CF₂—CF₂—CF₂—CF₂—CF₃ | 154,000 |
| A-4 | —CH₂—CH₂— | —CF₂—CF₂—CF₂—CF₃ | 32,000 |
| A-5 | —CH₂—CH₂— | —CF₂—CF₂—CF₂—CF₃ | 51,000 |
| A-6 | —CH₂—CH₂— | —CF₂—CF₂—CF₂—CF₃ | 120,000 |
| A-7 | —CH₂—CH₂— | —CF₂—CF₂—CF₂—CF₃ | 183,000 |
| A-8 | —CH₂—CH₂— | —CF₂—CF₂—CF₂—CF₃ | 253,000 |
| A-9 | —CH₂—CH₂— | —CF₂—CF₂—CF₂—CF₃ | 269,000 |
| A-10 | —CH₂—CH₂— | —CF₂—CF₂—CF₂—CF₃ | 301,000 |
| A-11 | —CH₂—CH₂— | —CF₂—CF₂—CF₂—CF₃ | 151,000 |
| A-12 | —CH₂—CH₂— | —CF₂—CF₂—CF₂—CF₃ | 152,000 |
| A-13 | —CH₂—CH₂— | —CF₂—CF₂—CF₂—CF₃ | 150,000 |
| A-14 | —CH₂—CH₂— | —CF₂—CF₂—CF₂—CF₃ | 153,000 |
| A-15 | —CH₂—CH₂— | —CF₂—CF₂—CF₂—CF₃ | 151,000 |
| A-16 | —CH₂—CH₂— | —CF₂—CF₂—CF₂—CF₃ | 151,000 |

The resultant graft copolymers B-1 to B-9 were each subjected to GPC measurement by the above-mentioned method to calculate a number-average molecular weight and a peak top molecular weight. The results are shown in Table 5.

TABLE 5

| | | | GPC measurement result | |
|---|---|---|---|---|
| Number of | | | Number-average | Peak top |
| graft | Unit structure represented by formula (2) | | molecular | molecular |
| copolymer | R¹² | Rf² | weight | weight |
| B-1 | —CH₂—CH₂— | —CF₂—CF₂—CF₂—CF₃ | 11,000 | 24,200 |
| B-2 | —CH₂—CH₂— | —CF₂—CF₂—CF₃ | 11,000 | 24,200 |
| B-3 | —CH₂—CH₂— | —CF₂—CF₂—CF₂—CF₂—CF₃ | 11,000 | 24,200 |
| B-4 | —CH₂—CH₂— | —CF₂—CF₂—CF₂—CF₃ | 13,000 | 40,000 |
| B-5 | —CH₂—CH₂— | —CF₂—CF₂—CF₂—CF₃ | 15,000 | 24,200 |
| B-6 | —CH₂—CH₂— | —CF₂—CF₂—CF₂—CF₃ | 65,000 | 21,000 |
| B-7 | —CH₂—CH₂— | —CF₂—CF₂—CF₂—CF₃ | 14,000 | 45,000 |
| B-8 | —CH₂—CH₂— | —CF₂—CF₂—CF₂—CF₃ | 93,000 | 25,000 |
| B-9 | —CH₂—CH₂— | —CF₂—CF₂—CF₂—CF₃ | 17,000 | 25,000 |

### <Production of Electrophotographic Photosensitive Member>

### [Photosensitive Member 1]

### (Support 1)

A product obtained by cutting a cylindrical aluminum cylinder (JIS-A3003, aluminum alloy, outer diameter: 30.6 mm, length: 370 mm, wall thickness: 1 mm) was used as a support (electroconductive support). The support was subjected to ultrasonic cleaning in a cleaning liquid obtained by incorporating a detergent (product name: CHEMICOL CT, manufactured by Tokiwa Chemical Industries Co., Ltd.) into pure water, and subsequently, the cleaning liquid was washed off. After that, the cleaned product was further subjected to ultrasonic cleaning in pure water to be subjected to degreasing treatment. The resultant was used as a support 1.

### (Undercoat Layer 1)

100 Parts of zinc oxide particles (specific surface area: 19 m²/g, powder resistance: 4.7×10⁶ (Ω·cm) were stirred and mixed with 500 parts of toluene, and 0.8 part of a silane coupling agent (compound name: N-2-(aminoethyl)-3-aminopropylmethyldimethoxysilane, product name: KBM-602, manufactured by Shin-Etsu Chemical Co., Ltd.) was added to the mixture, followed by stirring for 6 hours. After that, toluene was evaporated under reduced pressure, and the residue was heated and dried at 130° C. for 6 hours to provide surface-treated zinc oxide particles A.

Subsequently, 15 parts of a butyral resin (product name: BM-1, manufactured by Sekisui Chemical Company, Limited) serving as a polyol and 15 parts of a blocked isocyanate (product name: DURANATE TPA-B80E, non-volatile content: 80 mass %, manufactured by Asahi Kasei Chemicals Corporation) were dissolved in a mixed solvent containing 73.5 parts of methyl ethyl ketone and 73.5 parts of 1-butanol. 80.8 Parts of the surface-treated zinc oxide particles A and 0.81 part of 2,3,4-trihydroxybenzophenone (manufactured by Tokyo Chemical Industry Co., Ltd.) were added to the solution, and the materials were dispersed with a sand mill apparatus using glass beads each having a diameter of 0.8 mm under an atmosphere at 23° C.±3° C. for 3 hours.

After the dispersion treatment, 0.01 part of a silicone oil (product name: SH28PA, manufactured by Dow Corning Toray Co., Ltd. (former Dow Corning Toray Silicone Co., Ltd.)) and 5.6 parts of crosslinked polymethyl methacrylate (PMMA) particles (product name: TECHPOLYMER SSX-103, manufactured by Sekisui Kasei Co., Ltd., average primary particle diameter: 3 μm) were added to the resultant, and the mixture was stirred to prepare a coating liquid for an undercoat layer.

The resultant coating liquid for an undercoat layer was applied onto the above-mentioned support 1 by dip coating to form a coating film, and the coating film was dried at 160° C. for 30 minutes to form an undercoat layer 1 having a thickness of 18 μm.

### (Charge-Generating Layer 1)

4 Parts of a hydroxygallium phthalocyanine crystal (charge-generating substance) of a crystal form having strong peaks at Bragg angles 2θ±0.2° of 7.4° and 28.1° in CuKα characteristic X-ray diffraction, and 0.04 part of a compound represented by the following formula (E) were added to a liquid obtained by dissolving 2 parts of polyvinyl butyral (product name: S-LEC BX-1, manufactured by Sekisui Chemical Company, Limited) in 100 parts of cyclohexanone. After that, the mixture was subjected to dispersion treatment with a sand mill using glass beads each having a diameter of 1 mm under an atmosphere at 23° C.±3° C. for 1 hour. After the dispersion treatment, 100 parts of ethyl acetate was added to the resultant to prepare a coating liquid for a charge-generating layer.

The coating liquid for a charge-generating layer was applied onto the undercoat layer 1 by dip coating, and the resultant coating film was dried at 90° C. for 10 minutes to form a charge-generating layer 1 having a thickness of 0.15 μm.

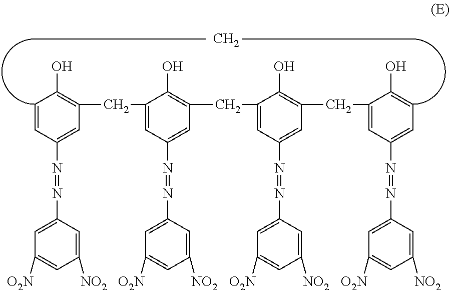

### (Charge-Transporting Layer 1)

60 Parts of a compound represented by the following formula (F), 30 parts of a compound represented by the following formula (G), 10 parts of a compound represented by the following formula (H), 100 parts of a bisphenol Z type polycarbonate resin (product name: IUPILON Z400, manufactured by Mitsubishi Engineering-Plastics Corporation), and 0.2 part of polycarbonate having a structural unit represented by the following formula (I) (viscosity-average molecular weight Mv: 20,000) were dissolved in a mixed solvent containing 272 parts of o-xylene, 256 parts of methyl benzoate, and 272 parts of dimethoxymethane to prepare a coating liquid for a charge-transporting layer.

The coating liquid for a charge-transporting layer was applied onto the above-mentioned charge-generating layer 1 by dip coating to form a coating film, and the resultant coating film was dried at 115° C. for 50 minutes to form a charge-transporting layer 1 having a thickness of 18 μm.

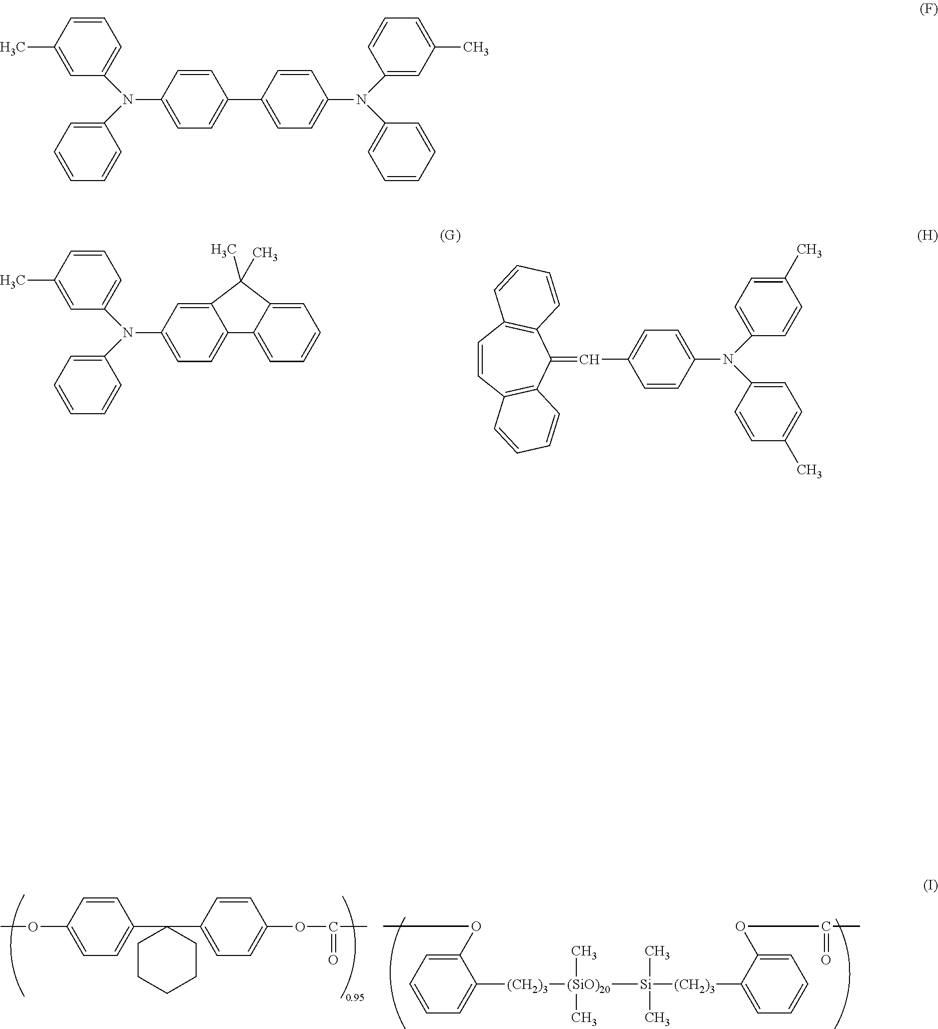

In the formula (I), 0.95 and 0.05 represent the molar ratios (copolymerization ratios) of the two structural units.

### (Protective Layer 1)

2.8 Parts of the above-mentioned graft copolymer A-1 was dissolved in a mixed solvent formed of 100 parts of 1,1,2,2-tetrafluoroethyl-2,2,2-trifluoroethyl ether (product name: AE-3000, manufactured by AGC Inc.) and 100 parts of 1-propanol to prepare a dispersant solution.

40 Parts of commercially available polytetrafluoroethylene resin particles (average primary particle diameter: 210 nm, average circularity: 0.85) were added to the resultant dispersant solution. Then, the mixture was passed through a high-pressure dispersing machine (product name: MICROFLUIDIZER M-110EH, manufactured by Microfluidics, USA) to provide a polytetrafluoroethylene resin particle dispersion liquid.

75.4 Parts of a hole-transportable compound represented by the following formula (B), 21.9 parts of a compound represented by the following formula (C), and 100 parts of 1-propanol were added to the resultant polytetrafluoroethylene resin particle dispersion liquid. After that, the mixture was filtered with a polyflon filter (product name: PF-040, manufactured by Advantec Toyo Kaisha, Ltd.) to prepare a polytetrafluoroethylene resin particle dispersion liquid (coating liquid for a protective layer).

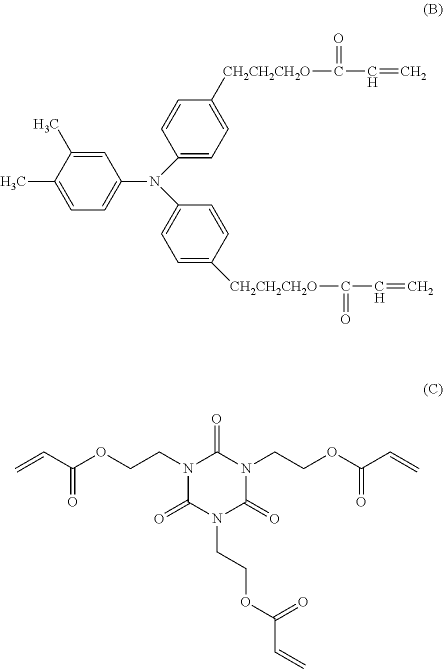

The coating liquid for a protective layer was applied onto the charge-transporting layer 1 by dip coating to form a coating film, and the resultant coating film was dried at 40° C. for 5 minutes. After the drying, under a nitrogen atmosphere, the coating film was irradiated with electron beams for 1.6 seconds under the conditions of an acceleration voltage of 70 kV and an absorbed dose of 15 kGy. After that, under the nitrogen atmosphere, the coating film was subjected to heating treatment for 15 seconds under such a condition that its temperature became 135° C. An oxygen concentration during a time period from the electron beam irradiation to the 15 seconds of heating treatment was 15 ppm. Next, in the air, the coating film was naturally cooled until its temperature became 25° C. After that, the coating film was subjected to heating treatment for 1 hour under such a condition that its temperature became 105° C. Thus, a surface layer (protective layer 1) having a thickness of 5 μm was formed.

Thus, an electrophotographic photosensitive member 1 including the support and the surface layer before its surface polishing was produced.

### <Surface Processing of Electrophotographic Photosensitive Member>

### (Polishing of Electrophotographic Photosensitive Member Before Surface Polishing)

The surface of the electrophotographic photosensitive member before the formation of a surface shape was polished. The polishing was performed with the polishing apparatus of FIG. 2 under the following conditions.

| Feeding speed of polishing sheet; | 400 | mm/min |
|---|---|---|
| Number of revolutions of electrophotographic | 450 | rpm |
| photosensitive member; | | |
| Indentation of electrophotographic | 3.5 | mm |
| photosensitive member into backup roller; | | |
| Feeding direction of polishing sheet and | identical with each other | |
| rotation direction of electrophotographic | | |
| photosensitive member; | | |

| | |
|---|---|
| Backup roller; outer diameter: | 100 mm, Asker C |
| | hardness: 25 |

A polishing sheet A to be mounted on the polishing apparatus was produced by mixing polishing abrasive grains used in GC3000 and GC2000 manufactured by Riken Corundum Co., Ltd.
GC3000 (polishing sheet surface roughness Ra: 0.83 μm)
GC2000 (polishing sheet surface roughness Ra: 1.45 μm)
Polishing sheet A (polishing sheet surface roughness Ra: 1.12 μm)

The time period for which the polishing was performed with the polishing sheet A was set to 20 seconds.

### (Measurement of Polishing Depth L (μm))

The maximum height Rmax in accordance with JIS B 0601 1982 was measured for the electrophotographic photosensitive member after the polishing with a surface roughness measuring instrument SURFCORDER SE3500 manufactured by Kosaka Laboratory Ltd. Measurement conditions were set as described below. The measurement was performed at 3 arbitrary sites in the 5-millimeter square range of the photosensitive electrophotographic photosensitive member after the polishing, and the average of the measured values was adopted as the polishing depth L (μm). The polishing depth L of the electrophotographic photosensitive member after the surface polishing was 0.75 μm. In addition, in Examples 1-2 to 1-25 to be described later, all the polishing depths L of electrophotographic photosensitive members subjected to surface processing were 0.75 μm.

### (Measurement Conditions)

Detector: R 2 μm
Stylus: A diamond stylus having a measuring force
of 0.7 mN
Filter: 2CR
Cut-off value: 0.08 mm
Measurement length: 2.5 mm
Feeding speed: 0.1 mm/sec

### [Electrophotographic Photosensitive Members 2 to 16 and 23]

Electrophotographic photosensitive members 2 to 16 and 23 were each produced in the same manner as in the production of the electrophotographic photosensitive member 1 except that in the formation of the protective layer, the graft copolymer A-1 was changed to a graft copolymer shown in Table 6.

### [Electrophotographic Photosensitive Members 17 to 20]

Electrophotographic photosensitive members 17 to 20 were each produced in the same manner as in the production of the electrophotographic photosensitive member 1 except that in the formation of the protective layer, the amount of the graft copolymer A-1 was changed to a number of parts by mass shown in Table 6.

### [Electrophotographic Photosensitive Member 21]

An electrophotographic photosensitive member 21 was produced in the same manner as in the production of the electrophotographic photosensitive member 1 except that in the formation of the protective layer, the protective layer was changed to a protective layer 2 formed as described below.

### (Protective Layer 2)

2.80 Parts of the above-mentioned graft copolymer A-1 was dissolved in a mixed solvent formed of 100 parts of 1,1,2,2-tetrafluoroethyl-2,2,2-trifluoroethyl ether (product name: AE-3000, manufactured by AGC Inc.) and 100 parts of 1-propanol to prepare a dispersant solution.

40 Parts of polytetrafluoroethylene resin particles (average primary particle diameter: 210 nm, average circularity: 0.85) were added to the resultant dispersant solution. Then, the mixture was passed through a high-pressure dispersing machine (product name: MICROFLUIDIZER M-110EH, manufactured by Microfluidics, USA) to provide a polytetrafluoroethylene resin particle dispersion liquid.

97.3 Parts of the hole-transportable compound represented by the formula (B) and 100 parts of 1-propanol were added to the resultant polytetrafluoroethylene resin particle dispersion liquid. After that, the mixture was filtered with a polyflon filter (product name: PF-040, manufactured by Advantec Toyo Kaisha, Ltd.) to prepare a polytetrafluoroethylene resin particle dispersion liquid (coating liquid for a protective layer).

The coating liquid for a protective layer was applied onto a charge-transporting layer by dip coating to form a coating film, and the resultant coating film was dried at 40° C. for 5 minutes. After the drying, under a nitrogen atmosphere, the coating film was irradiated with electron beams for 1.6 seconds under the conditions of an acceleration voltage of 70 kV and an absorbed dose of 15 kGy. After that, under the nitrogen atmosphere, the coating film was subjected to heating treatment for 15 seconds under such a condition that its temperature became 135° C. An oxygen concentration during a time period from the electron beam irradiation to the 15 seconds of heating treatment was 15 ppm. Next, in the air, the coating film was naturally cooled until its temperature became 25° C. After that, the coating film was subjected to heating treatment for 1 hour under such a condition that its temperature became 105° C. Thus, a surface layer (protective layer 2) having a thickness of 5 μm was formed.

### [Electrophotographic Photosensitive Member 22]

An electrophotographic photosensitive member 22 was produced in the same manner as in the production of the electrophotographic photosensitive member 1 except that in the formation of the protective layer, the protective layer was changed to a protective layer 3 formed as described below.

### (Protective Layer 3)

4.80 Parts of the above-mentioned graft copolymer A-1 was dissolved in 80 parts of tetrahydrofuran to prepare a dispersant solution.

24 Parts of polytetrafluoroethylene resin particles (average primary particle diameter: 210 nm, average circularity: 0.85) were added to the resultant dispersant solution. Then, the mixture was passed through a high-pressure dispersing machine (product name: MICROFLUIDIZER M-110EH, manufactured by Microfluidics, USA) to provide a polytetrafluoroethylene resin particle dispersion liquid.

115 Parts of a hole-transportable compound represented by the following formula (C-26), 8.00 parts of a triazine compound represented by the following formula (A-15), 2.17 parts of dodecylbenzenesulfonic acid, and 0.29 part of an antioxidant were added to the resultant polytetrafluoroethylene resin particle dispersion liquid.

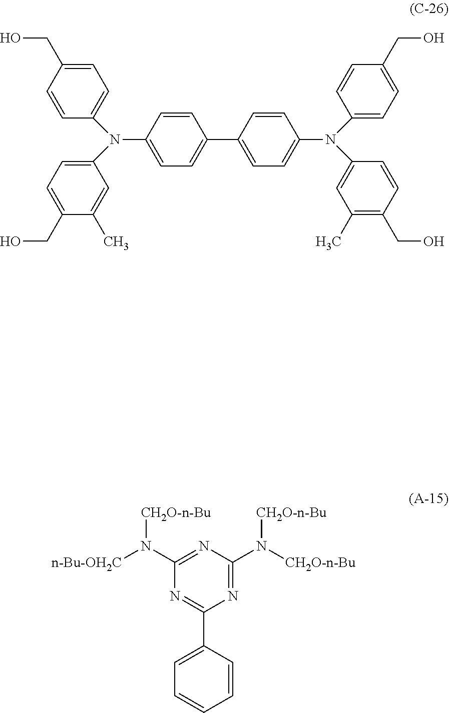

After that, the mixture was filtered with a polyflon filter (product name: PF-040, manufactured by Advantec Toyo Kaisha, Ltd.) to prepare a polytetrafluoroethylene resin particle dispersion liquid (coating liquid for a protective layer).

The coating liquid for a protective layer was applied onto a charge-transporting layer by dip coating to form a coating film, and the resultant coating film was dried at 40° C. for 5 minutes. After the drying, under a nitrogen atmosphere, the coating film was irradiated with electron beams for 1.6 seconds under the conditions of an acceleration voltage of 70 kV and an absorbed dose of 15 kGy. After that, under the nitrogen atmosphere, the coating film was subjected to heating treatment for 15 seconds under such a condition that its temperature became 135° C. An oxygen concentration during a time period from the electron beam irradiation to the 15 seconds of heating treatment was 15 ppm. Next, in the air, the coating film was naturally cooled until its temperature became 25° C. After that, the coating film was subjected to heating treatment for 1 hour under such a condition that its temperature became 105° C. Thus, a surface layer (protective layer 3) having a thickness of 5 μm was formed.

TABLE 6

| | | Mass of graft |
|---|---|---|
| | Number of graft | copolymer |
| | copolymer | [part(s)] |
| Photosensitive | A-1 | 2.80 |
| member 1 | | |
| Photosensitive | A-2 | 2.80 |
| member 2 | | |
| Photosensitive | A-3 | 2.80 |
| member 3 | | |
| Photosensitive | A-4 | 2.80 |
| member 4 | | |
| Photosensitive | A-5 | 2.80 |
| member 5 | | |
| Photosensitive | A-6 | 2.80 |
| member 6 | | |
| Photosensitive | A-7 | 2.80 |
| member 7 | | |
| Photosensitive | A-8 | 2.80 |
| member 8 | | |
| Photosensitive | A-9 | 2.80 |
| member 9 | | |
| Photosensitive | A-10 | 2.80 |
| member 10 | | |
| Photosensitive | A-11 | 2.80 |
| member 11 | | |
| Photosensitive | A-12 | 2.80 |
| member 12 | | |
| Photosensitive | A-13 | 2.80 |
| member 13 | | |
| Photosensitive | A-14 | 2.80 |
| member 14 | | |
| Photosensitive | A-15 | 2.80 |
| member 15 | | |
| Photosensitive | A-16 | 2.80 |
| member 16 | | |
| Photosensitive | A-1 | 0.40 |
| member 17 | | |
| Photosensitive | A-1 | 1.60 |
| member 18 | | |
| Photosensitive | A-1 | 3.60 |
| member 19 | | |
| Photosensitive | A-1 | 4.40 |
| member 20 | | |
| Photosensitive | A-1 | 2.80 |
| member 21 | | |
| Photosensitive | A-1 | 4.80 |
| member 22 | | |
| Photosensitive | B-1 | 2.80 |
| member 23 | | |

### <Production of Intermediate Transfer Belt>

### [Preparation of Dispersion Liquid for Forming Surface Layer]

The following materials were mixed and dispersed in a stirring type homogenizer (manufactured by AS ONE Corporation), and were then dispersed with a dispersing apparatus (product name: Nanomizer, manufactured by Yoshida Kikai Co., Ltd.) to provide a dispersion liquid for forming a surface layer.

| | | |
|---|---|---|
| Dipentaerythritol hexaacrylate (DPHA) | 7.0 | parts by mass |
| Pentaerythritol tetraacrylate (PETTA) | 15.0 | parts by mass |
| Pentaerythritol triacrylate (PETA) | 4.4 | parts by mass |
| Methyl ethyl ketone | 26.4 | parts by mass |
| Antimony-doped tin oxide fine particles | 4.5 | parts by mass |
| (product name: SN-100P; manufactured by | | |
| Ishihara Sangyo Kaisha, Ltd.) | | |
| Photopolymerization initiator 1 (product name: | 2.0 | parts by mass |
| OMNIRAD 4; manufactured by IGM Resins) | | |
| PFPE 1 (product name: Fluorolink MD700; | 14.8 | parts by mass |
| manufactured by Solvay Specialty Polymers) | | |
| Graft copolymer B-1 | 25.9 | parts by mass |

### [Intermediate Transfer Belt 1]

An intermediate transfer belt made of polyimide, which was provided in a color electrophotographic apparatus (product name: iRC2620; manufactured by Canon Inc.), was used as the base layer 31. The dispersion liquid prepared above was applied onto the outer peripheral surface of the base layer 31, and was dried at a temperature of 70° C. for 3 minutes to form a coating film of the dispersion liquid for forming a surface layer.

Then, the coating film was cured by irradiation with UV light at 500 mJ/cm² through use of a UV treatment apparatus (manufactured by Eye Graphics Co., Ltd.) to form a surface layer having a thickness of 4 μm. Thus, an intermediate transfer belt 1 was obtained.

The addition amount of a perfluoropolyether used and the kind and addition amount of a dispersant are shown in Table 7.

In Table 7, the addition amount of a perfluoropolyether and the addition amount of a dispersant are shown in terms of content in the total solid content. The total solid content was calculated as components of a composition having methyl ethyl ketone serving as a solvent and a solvent portion of the dispersant excluded therefrom.

### [Intermediate Transfer Belts 2 to 9 and 13]

Intermediate transfer belts 2 to 9 and 13 were each produced in the same manner as in the production of the intermediate transfer belt 1 except that in the preparation of the dispersion liquid for forming a surface layer, the graft copolymer B-1 was changed to a graft copolymer shown in Table 7.

### [Intermediate Transfer Belts 10 to 12]

Intermediate transfer belts 10 to 12 were each produced in the same manner as in the production of the intermediate transfer belt 1 except that in the preparation of the dispersion liquid for forming a surface layer, the addition amount of the graft copolymer B-1 was changed to an addition amount shown in Table 7.

TABLE 7

| | | | Addition |
|---|---|---|---|
| | Number of | Addition | amount of |
| | graft | amount | perfluoropolyether |
| | copolymer | (%) | (%) |
| Intermediate transfer | B-1 | 16.0 | 26.1 |
| belt 1 | | | |
| Intermediate transfer | B-2 | 16.0 | 26.1 |
| belt 2 | | | |
| Intermediate transfer | B-3 | 16.0 | 26.1 |
| belt 3 | | | |
| Intermediate transfer | B-4 | 16.0 | 26.1 |
| belt 4 | | | |
| Intermediate transfer | B-5 | 16.0 | 26.1 |
| belt 5 | | | |
| Intermediate transfer | B-6 | 16.0 | 26.1 |
| belt 6 | | | |
| Intermediate transfer | B-7 | 16.0 | 26.1 |
| belt 7 | | | |
| Intermediate transfer | B-8 | 16.0 | 26.1 |
| belt 8 | | | |
| Intermediate transfer | B-9 | 16.0 | 26.1 |
| belt 9 | | | |
| Intermediate transfer | B-1 | 16.0 | 20.0 |
| belt 10 | | | |
| Intermediate transfer | B-1 | 15.0 | 39.9 |
| belt 11 | | | |
| Intermediate transfer | B-1 | 25.0 | 26.1 |
| belt 12 | | | |
| Intermediate transfer | A-1 | 16.0 | 26.1 |
| belt 13 | | | |

### Examples 1 to 37 and Comparative Examples 1 and 2

The resultant electrophotographic photosensitive members 1 to 23 and intermediate transfer belts 1 to 13 were combined as shown in Table 8 to provide Examples 1 to 37 and Comparative Examples 1 and 2, and the evaluation of an initial image, the evaluation of drum discoloration after long-term suspension, and the evaluation of an image after long-term suspension were performed.

TABLE 8

| | Electropho- | |
|---|---|---|
| Numbers of Example | tographic | |
| and Comparative | photosensitive | |
| Example | member | Intermediate transfer belt |
| Example 1 | Photosensitive | Intermediate transfer belt 1 |
| | member 1 | |
| Example 2 | Photosensitive | Intermediate transfer belt 2 |
| | member 2 | |
| Example 3 | Photosensitive | Intermediate transfer belt 1 |
| | member 2 | |
| Example 4 | Photosensitive | Intermediate transfer belt 3 |
| | member 2 | |
| Example 5 | Photosensitive | Intermediate transfer belt 2 |
| | member 1 | |
| Example 6 | Photosensitive | Intermediate transfer belt 3 |
| | member 1 | |
| Example 7 | Photosensitive | Intermediate transfer belt 2 |
| | member 3 | |
| Example 8 | Photosensitive | Intermediate transfer belt 1 |
| | member 3 | |
| Example 9 | Photosensitive | Intermediate transfer belt 3 |
| | member 3 | |
| Example 10 | Photosensitive | Intermediate transfer belt 1 |
| | member 4 | |
| Example 11 | Photosensitive | Intermediate transfer belt 1 |
| | member 5 | |
| Example 12 | Photosensitive | Intermediate transfer belt 1 |
| | member 6 | |
| Example 13 | Photosensitive | Intermediate transfer belt 1 |
| | member 7 | |
| Example 14 | Photosensitive | Intermediate transfer belt 1 |
| | member 8 | |
| Example 15 | Photosensitive | Intermediate transfer belt 1 |
| | member 9 | |
| Example 16 | Photosensitive | Intermediate transfer belt 1 |
| | member 10 | |
| Example 17 | Photosensitive | Intermediate transfer belt 1 |
| | member 11 | |
| Example 18 | Photosensitive | Intermediate transfer belt 1 |
| | member 12 | |
| Example 19 | Photosensitive | Intermediate transfer belt 1 |
| | member 13 | |
| Example 20 | Photosensitive | Intermediate transfer belt 1 |
| | member 14 | |
| Example 21 | Photosensitive | Intermediate transfer belt 1 |
| | member 15 | |
| Example 22 | Photosensitive | Intermediate transfer belt 1 |
| | member 16 | |
| Example 23 | Photosensitive | Intermediate transfer belt 1 |
| | member 17 | |
| Example 24 | Photosensitive | Intermediate transfer belt 1 |
| | member 18 | |
| Example 25 | Photosensitive | Intermediate transfer belt 1 |
| | member 19 | |
| Example 26 | Photosensitive | Intermediate transfer belt 1 |
| | member 20 | |
| Example 27 | Photosensitive | Intermediate transfer belt 4 |
| | member 1 | |
| Example 28 | Photosensitive | Intermediate transfer belt 5 |
| | member 1 | |
| Example 29 | Photosensitive | Intermediate transfer belt 6 |
| | member 1 | |
| Example 30 | Photosensitive | Intermediate transfer belt 7 |
| | member 1 | |
| Example 31 | Photosensitive | Intermediate transfer belt 8 |
| | member 1 | |
| Example 32 | Photosensitive | Intermediate transfer belt 9 |
| | member 1 | |
| Example 33 | Photosensitive | Intermediate transfer belt |
| | member 1 | 10 |
| Example 34 | Photosensitive | Intermediate transfer belt |
| | member 1 | 11 |
| Example 35 | Photosensitive | Intermediate transfer belt |
| | member 1 | 12 |
| Example 36 | Photosensitive | Intermediate transfer belt 1 |
| | member 21 | |
| Example 37 | Photosensitive | Intermediate transfer belt 1 |
| | member 22 | |
| Comparative Example 1 | Photosensitive | Intermediate transfer belt |
| | member 1 | 13 |
| Comparative Example 2 | Photosensitive | Intermediate transfer belt 1 |
| | member 23 | |

### EVALUATION

An evaluation apparatus 1 and an evaluation apparatus 2 were used in the following evaluations.

### Evaluation Apparatus 1

An evaluation was performed by mounting the produced electrophotographic photosensitive member and intermediate transfer belt in a combination shown in Table 8 on a copying machine imagePRESS C800 (product name) manufactured by Canon Inc.

More specifically, the above-mentioned evaluation apparatus was placed under a normal-temperature and normal-humidity environment having a temperature of 23° C. and a relative humidity of 50% RH, and the produced electrophotographic photosensitive member was mounted on its process cartridge for a magenta color. The resultant was mounted on the station of the process cartridge for a magenta color, and the evaluation was performed.

### Evaluation Apparatus 2

An evaluation was performed by mounting the produced electrophotographic photosensitive member and intermediate transfer belt on a reconstructed machine of a copying machine imagePRESS C800 (product name) manufactured by Canon Inc. The charging unit of the reconstructed machine is a charging unit of such a system as to apply a voltage obtained by superimposing an AC voltage on a DC voltage to a roller type contact charging member (charging roller), and the exposing unit thereof is an exposing unit of a laser image exposure system (wavelength: 680 nm).

More specifically, the above-mentioned evaluation apparatus was placed under a high-temperature and high-humidity environment having a temperature of 30° C. and a relative humidity of 80% RH, and the produced electrophotographic photosensitive member was mounted on its process cartridge for a magenta color.

### (Initial Image Evaluation)

An image evaluation was performed by using the above-mentioned evaluation apparatus 1. An entirely solid white image was output on A4 size gloss paper, and the number of image defects due to a dispersion failure in the area of the output image corresponding to one round of the electrophotographic photosensitive member, that is, black spots was visually evaluated in accordance with the following evaluation ranks. The area corresponding to one round of the electrophotographic photosensitive member is a rectangular region measuring 297 mm, which is the length of the long side of the A4 paper, in a longitudinal direction and 94.2 mm, which is one round of the electrophotographic photosensitive member, in a lateral direction. In addition, in the present disclosure, ranks A, B, C, and D were the levels at which the effects of the present disclosure were obtained, and out of the ranks, the rank A was determined to be an excellent level. Meanwhile, a rank E was determined to be the level at which the effects of the present disclosure were not obtained.

Rank A: No black spot is present.

Rank B: The number of black spots each having a diameter of less than 1.5 mm is 1 or more to 3 or less, and no black spot having a diameter of 1.5 mm or more is present.

Rank C: The number of black spots each having a diameter of less than 1.5 mm is 1 or more to 3 or less, and the number of black spots each having a diameter of 1.5 mm or more is 1 or more to 2 or less.

Rank D: The number of black spots each having a diameter of less than 1.5 mm 4 or more to 5 or less, and the number of black spots each having a diameter of 1.5 mm or more is 2 or less.

Rank E: The number of black spots each having a diameter of less than 1.5 mm is 6 or more, or the number of black spots each having a diameter of 1.5 mm or more is 3 or more.

The evaluations were performed as described above. The evaluation results of Examples 1 to 37 and Comparative Examples 1 and 2 are shown in Table 9.

### (Measurement of Average Long Diameter of Domains)

The average long diameter of domains was measured by observing the cross-section of the surface layer 32 of the intermediate transfer belt with a scanning electron microscope (manufactured by Hitachi High-Tech Corporation, S-4800). First, a cross-section cut out from the surface layer 32 of the intermediate transfer belt with a microtome (manufactured by Leica Microsystems, product name: EM UC7) was used as a sample. In this case, a sectional SEM image in which at least one domain was able to be recognized in a unit area of 15 μm² when the cross-section was magnified by 20,000 times was used. When there were 10 or less domains, the long diameters of all the domains in a field of view were measured. In addition, when there were more than 10 domains, 10 domains were randomly selected, and the long diameters of the selected domains were measured. This operation was repeated 10 times for different positions of the cross-section, and the calculated average of the long diameters of a total of 100 domains measured in the 10 sectional SEM images was calculated. The resultant calculated average was adopted as the average long diameter of the domains in each of Examples and the Comparative Examples to be described later.

(Evaluation of Drum Discoloration after Long-Term Suspension)

The evaluation of drum discoloration after long-term suspension was performed by using the above-mentioned evaluation apparatus 2. A cartridge having mounted thereon the produced electrophotographic photosensitive member, and the produced intermediate transfer belt were installed in the evaluation apparatus, and were stored for 2 months under a high-temperature and high-humidity environment having a temperature of 30° C. and a relative humidity of 80% RH while the evaluation apparatus was suspended. After that, the discoloration of a portion of the surface of the electrophotographic photosensitive member that had been brought into abutment against the intermediate transfer belt was evaluated in accordance with the following evaluation ranks.

Rank A: No discoloration is observed.

Rank B: Discoloration is hardly observed.

Rank C: Discoloration is observed, but the discoloration is within a range of 50% or less of the portion that has been brought into abutment against the intermediate transfer belt.

Rank D: Discoloration is observed.

In addition, in the present disclosure, ranks A, B, and C were the levels at which the effects of the present disclosure were obtained, and out of the ranks, the rank A was determined to be an excellent level. Meanwhile, a rank D was determined to be the level at which the effects of the present disclosure were not obtained.

(Evaluation of Image after Long-Term Suspension)

The evaluation of an image after long-term suspension was performed by using the above-mentioned evaluation apparatus 2. A cartridge having mounted thereon the produced electrophotographic photosensitive member, and the produced intermediate transfer belt were installed in the evaluation apparatus, and were stored for 2 months under a high-temperature and high-humidity environment having a temperature of 30° C. and a relative humidity of 80% RH while the evaluation apparatus was suspended. After that, image formation was performed. In this case, the resultant image and the initial image before the storage under a high-temperature and high-humidity environment were visually observed and compared to each other, and the evaluation was performed in accordance with the following criteria.

Rank A: No deterioration of image quality caused by a transfer failure is observed.

Rank B: Deterioration of image quality caused by a transfer failure is hardly observed.

Rank C: Deterioration of image quality caused by a transfer failure occurs, but the deterioration occurs in 50% or less of a printing surface.

Rank D: Deterioration of image quality caused by a transfer failure occurs over the entire surface.

In addition, in the present disclosure, ranks A, B, and C were the levels at which the effects of the present disclosure were obtained, and out of the ranks, the rank A was determined to be an excellent level. Meanwhile, a rank D was determined to be the level at which the effects of the present disclosure were not obtained.

The evaluations were performed as described above. The evaluation results of Examples 1 to 37 and Comparative Examples 1 and 2 are shown in Table 9.

TABLE 9

| | Initial evaluation | | Evaluation after | |
|---|---|---|---|---|
| Numbers of | | Domain | long-term storage | |
| Example and | | diameter of | Drum | Image |
| Comparative | | intermediate | Discol- | evalu- |
| Example | Image | transfer belt | oration | ation |
| Example 1 | A | 20 | A | A |
| Example 2 | B | 20 | A | A |
| Example 3 | A | 20 | A | A |
| Example 4 | B | 20 | A | A |
| Example 5 | A | 20 | A | A |
| Example 6 | A | 20 | A | A |
| Example 7 | B | 20 | A | A |
| Example 8 | B | 20 | A | A |
| Example 9 | B | 20 | A | A |
| Example 10 | B | 20 | A | A |
| Example 11 | A | 20 | A | A |
| Example 12 | A | 20 | A | A |
| Example 13 | A | 20 | A | A |
| Example 14 | A | 20 | A | A |
| Example 15 | A | 20 | A | A |
| Example 16 | A | 20 | A | A |
| Example 17 | C | 20 | A | A |
| Example 18 | C | 20 | A | A |
| Example 19 | B | 20 | A | A |
| Example 20 | A | 20 | A | A |
| Example 21 | A | 20 | A | A |
| Example 22 | B | 20 | A | A |
| Example 23 | D | 20 | A | A |
| Example 24 | B | 20 | A | A |
| Example 25 | A | 20 | A | A |
| Example 26 | A | 20 | A | A |
| Example 27 | A | 60 | A | A |
| Example 28 | A | 30 | A | A |
| Example 29 | A | 300 | C | C |
| Example 30 | A | 150 | B | B |
| Example 31 | A | 180 | B | B |
| Example 32 | A | 250 | C | B |
| Example 33 | A | 40 | A | A |
| Example 34 | A | 40 | B | A |
| Example 35 | A | 20 | A | A |
| Example 36 | A | 20 | A | A |
| Example 37 | A | 20 | A | A |
| Comparative Example 1 | A | 30 | D | D |
| Comparative Example 2 | B | 20 | D | D |

According to one aspect of the present disclosure, there can be provided an electrophotographic apparatus including: an electrophotographic photosensitive member excellent in dispersibility of polytetrafluoroethylene particles serving as fluorine atom-containing resin particles in a surface layer; and an intermediate transfer belt excellent in dispersibility of a perfluoropolyether in a surface layer that is allowed to be brought into abutment against the electrophotographic photosensitive member, in which an image defect caused by exudation of the perfluoropolyether from the intermediate transfer belt to the electrophotographic photosensitive member after long-term suspension is suppressed.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-005963, filed Jan. 18, 2023, and Japanese Patent Application No. 2023-209556, filed Dec. 12, 2023, which are hereby incorporated by reference herein in their entirety.

What is claimed is:

1. An electrophotographic apparatus comprising:
an electrophotographic photosensitive member; and
an intermediate transfer belt that is allowed to be brought into abutment against the electrophotographic photosensitive member,
wherein the electrophotographic photosensitive member comprises a surface layer comprising:
polytetrafluoroethylene particles,
a binding material, and
a polymer A including a structural unit having a perfluoroalkyl group,
wherein the intermediate transfer belt comprises a surface layer comprising:
a perfluoropolyether,
a binding material, and
a polymer B comprising a structural unit having a perfluoroalkyl group,
wherein the polymer A comprises a structural unit represented by the following formula (1) as the structural unit having a perfluoroalkyl group, and
wherein the polymer B comprises a structural unit represented by the following formula (2) as the structural unit having a perfluoroalkyl group: 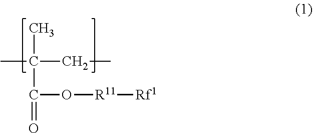
in the formula (1),
R¹¹ represents a single bond or an alkylene group having 1 or more to 3 or less carbon atoms, and
Rf¹ represents a perfluoroalkyl group having 1 or more to 5 or less carbon atoms; 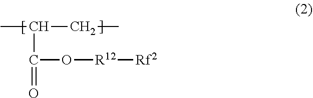
in the formula (2),
R¹² represents a single bond or an alkylene group having 1 or more to 3 or less carbon atoms, and
Rf² represents a perfluoroalkyl group having 1 or more to 5 or less carbon atoms.

2. The electrophotographic apparatus according to claim 1,
wherein when a mass of the structural unit having a perfluoroalkyl group included in the polymer A is represented by MTA, and a mass of the structural unit represented by the formula (1) included in the polymer A is represented by MIA, the following formula (i) is satisfied:
$$0.5 < M 1 A / MTA \leq 1. , \qquad ( i )$$
and
wherein when a mass of the structural unit having a perfluoroalkyl group included in the polymer B is represented by MTB, and a mass of the structural unit represented by the formula (2) included in the polymer B is represented by M2B, the following formula (ii) is satisfied:
$$0.5 < M 2 B / MTB \leq 1. . \qquad ( ii )$$

3. The electrophotographic apparatus according to claim 1, wherein the number of carbon atoms of Rf¹ in the formula (1) is 2 or more to 4 or less.

4. The electrophotographic apparatus according to claim 1, wherein the number of carbon atoms of Rf² in the formula (2) is 2 or more to 4 or less.

5. The electrophotographic apparatus according to claim 1, wherein the polymer A has a weight-average molecular weight of 16,000 or more to 300,000 or less.

6. The electrophotographic apparatus according to claim 1, wherein a content of the structural unit represented by the formula (1) in the polymer A is 5 number % or more to 50 number % or less with respect to all structural units in the polymer A.

7. The electrophotographic apparatus according to claim 1, wherein a content of the polymer A in the surface layer of the electrophotographic photosensitive member is 2 mass % or more to 10 mass % or less with respect to a mass of the polytetrafluoroethylene particles in the surface layer of the electrophotographic photosensitive member.

8. The electrophotographic apparatus according to claim 1, wherein the polymer A further has a structural unit represented by the following formula (M): 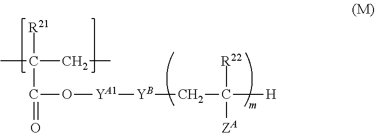
in the formula (M),
Y^{A1} represents an unsubstituted alkylene group,
Y^{B} represents an unsubstituted alkylene group, an alkylene group substituted with a halogen atom, an alkylene group substituted with a hydroxy group, an ester bond (—COO—), an amide bond (—NHCO—), or a urethane bond (—NHCOO—), or a divalent linking group that may be derived by combining one or more kinds selected from these groups and bonds, and —O— or —S—, or a single bond,
Z^{A} represents a structure represented by the following formula (2A), a cyano group, or a phenyl group,
R²¹ and R²² each independently represent a hydrogen atom or a methyl group, and
“m” represents an integer of 25 or more to 150 or less; 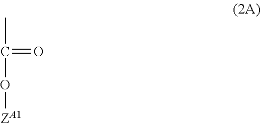
in the formula (2A), Z^{A1} represents an alkyl group having 1 or more to 4 or less carbon atoms.

9. The electrophotographic apparatus according to claim 8, wherein the polymer A has only the structural unit represented by the formula (1) and the structural unit represented by the formula (M) as structural units thereof.

10. The electrophotographic apparatus according to claim 8, wherein a ratio between the structural unit represented by the formula (1) and the structural unit represented by the formula (M) in the polymer A (formula (1):formula (M)) is 1:19 to 1:1 in terms of molar ratio.

11. The electrophotographic apparatus according to claim 1, wherein a content of the polytetrafluoroethylene particles in the surface layer of the electrophotographic photosensitive member is 5 mass % or more to 40 mass % or less with respect to a total mass of the surface layer of the electrophotographic photosensitive member.

12. The electrophotographic apparatus according to claim 1, wherein the binding material in the surface layer of the electrophotographic photosensitive member is a cured product of a hole-transportable compound having a chain-polymerizable functional group.

13. The electrophotographic apparatus according to claim 12, wherein the hole-transportable compound having a chain-polymerizable functional group is a compound represented by the following formula (CT-1) or (CT-2): 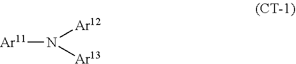
in the formula (CT-1), Ar¹¹ to Ar¹³ each independently represent a substituted aryl group or an unsubstituted aryl group, and a substituent that the substituted aryl group may have is an alkyl group having 1 or more to 6 or less carbon atoms, or a monovalent functional group represented by any one of the following formulae (P-1) to (P-3), provided that the compound represented by the formula (CT-1) has at least one monovalent functional group represented by any one of the following formulae (P-1) to (P-3); 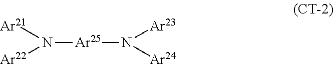
in the formula (CT-2), Ar²¹ to Ar²⁴ each independently represent a substituted aryl group or an unsubstituted aryl group, Ar²⁵ represents a substituted arylene group or an unsubstituted arylene group, a substituent that the substituted aryl group may have is an alkyl group having 1 or more to 6 or less carbon atoms, or a monovalent functional group represented by any one of the following formulae (P-1) to (P-3), and a substituent that the substituted arylene group may have is an alkyl group having 1 or more to 6 or less carbon atoms, or a monovalent functional group represented by any one of the following formulae (P-1) to (P-3), provided that the compound represented by the formula (CT-2) has at least one monovalent functional group represented by any one of the following formulae (P-1) to (P-3); 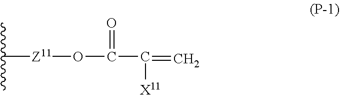
in the formula (P-1), Z¹¹ represents a single bond or an alkylene group having 1 or more to 6 or less carbon atoms, and X¹¹ represents a hydrogen atom or a methyl group; 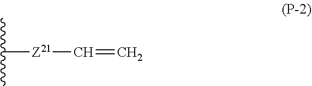
in the formula (P-2), Z²¹ represents a single bond or an alkylene group having 1 or more to 6 or less carbon atoms; 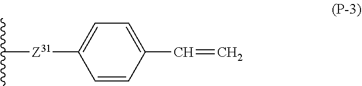
in the formula (P-3), Z³¹ represents a single bond or an alkylene group having 1 or more to 6 or less carbon atoms.

14. The electrophotographic apparatus according to claim 1, wherein the surface layer of the electrophotographic photosensitive member further contains a compound represented by the following formula (3): 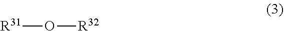
in the formula (3),
R³¹ represents an alkyl group having 1 or more to 6 or less carbon atoms, or a fluoroalkyl group having 1 or more to 6 or less carbon atoms, and
R³² represents a fluoroalkyl group having 1 or more to 6 or less carbon atoms.

15. The electrophotographic apparatus according to claim 1, wherein the polymer B has a number-average molecular weight of 11,000 or more to 15,000 or less and a peak top molecular weight of 24,000 or more to 40,000 or less.

16. The electrophotographic apparatus according to claim 1, wherein the binding material in the intermediate transfer belt is an acrylic resin.

17. The electrophotographic apparatus according to claim 1, wherein a content of the perfluoropolyether in the surface layer of the intermediate transfer belt is 20 mass % or more to 40 mass % or less with respect to a total solid content of the surface layer.

18. The electrophotographic apparatus according to claim 1, wherein a content of the polymer B in the surface layer of the intermediate transfer belt is 5 mass % or more to 30 mass % or less with respect to a total solid content of the surface layer.

19. The electrophotographic apparatus according to claim 1,
wherein the surface layer of the intermediate transfer belt has, in a thickness direction thereof, a matrix-domain structure comprising a matrix containing the binding material and a domain containing the perfluoropolyether, and
wherein the domain has an average long diameter of 1 nm or more to 60 nm or less.

20. The electrophotographic apparatus according to claim 1,
wherein the surface layer of the electrophotographic photosensitive member is a layer formed by forming a coating film of a coating liquid for a surface layer containing the polymer A, at least any one selected from a binding material and a raw material for the binding material, and the polytetrafluoroethylene particles, and drying and/or curing the coating film, and
wherein the surface layer of the intermediate transfer belt is a layer formed by forming a coating film of a coating liquid for a surface layer containing the polymer B, at least any one selected from a binding material and a raw material for the binding material, and the perfluoropolyether, and drying and/or curing the coating film.
